(19) United States
(12) Patent Application Publication
(10) Pub. No.: US 2014/0122350 A1
(43) Pub. Date: May 1, 2014

(54) SYSTEM, APPARATUS, AND METHOD FOR LICENSE MANAGEMENT

(71) Applicants: Ryo TAKEMOTO, Kanagawa (JP); Kohta Nagai, Kanagawa (JP)

(72) Inventors: Ryo TAKEMOTO, Kanagawa (JP); Kohta Nagai, Kanagawa (JP)

(73) Assignee: Ricoh Company, Ltd., Tokyo (JP)

(21) Appl. No.: 14/061,853

(22) Filed: Oct. 24, 2013

(30) Foreign Application Priority Data
Oct. 26, 2012 (JP) 2012-236409
Oct. 26, 2012 (JP) 2012-236410

(51) Int. Cl. G06Q 30/00

(52) U.S. Cl. CPC G06Q 30/018
USPC 705/317

(57) ABSTRACT

A license management apparatus includes a reception unit that receives identification data of a second license corresponding to a predetermined service, a search unit that searches for license data of a first license corresponding to a service matching the predetermined service, in a storage unit that stores license data including status data of each license, and a transmission unit that transmits a search result of the search by the search unit. The second license is a license that is not yet used and the first license is a license that is currently used.

### BACKGROUND OF THE INVENTION

1. Field of the Invention

The present invention relates to a system, an apparatus, and a method for license management.

2. Description of the Related Art

License management is commonly performed where a service is provided by using software or the like. For example, in a case where a user purchases a license corresponding to a service that the user wishes to use, license data including, for example, data pertaining to the license, is managed on the service provider side. In a case where the user requests to use the service, use of the service is allowed if the content of the request is within the scope of the content of the license granted to the user.

One of the parameters that define the content of a license is a validity period. If the validity period of a license (or service) expires, the user can no longer use the service corresponding to the license. Therefore, in a case where the user desires to continue using the service after the validity period of the service expires, the user performs a procedure of updating the validity period of the license.

However, in a case where a user uses many services, many licenses need to be managed. Thus, it is difficult for the user to find a candidate license that is to be updated among the many licenses. Even if a searching unit is prepared, it is still difficult to create appropriate search conditions for searching the candidate license due to the many parameters that define the content of the license.

In one related art example, an updating procedure of a validity period of a license is performed by updating an expiration date of the validity period that is managed in correspondence with the license.

First, a license is given to a user when a usage contract to use a service is concluded between a service provider (e.g., seller of service) and the user. The usage contract may be concluded not only when the user starts the use of the service but also when updating the validity period of the license that the user has purchased.

With the updating method of the related art example in which the expiration date of the validity period of the license is updated, it is difficult to manage a license with respect to each usage contract. That is, it is difficult to manage a license and a usage contract on a one-on-one basis. For example, when a validity period of a license “A” is updated according to the related art example, a second usage contract would be generated. That is, in addition to a first usage contract that was generated at the time of purchasing the license “A”, a second usage contract is generated when the validity period of the license “A” is updated (i.e. generation of two usage contracts). However, because a single license data is managed in correspondence license “A”, the license data is to be associated to the two usage contracts in a case where an expiration date of a validity period of license “A” included in the license data is updated.

This leads to difficulty, for example, when identifying the usage contract that a currently used license “A” is based on.

### SUMMARY OF THE INVENTION

The present invention may provide a system, an apparatus, and a method for license management that substantially obviates one or more of the problems caused by the limitations and disadvantages of the related art.

Features and advantages of the present invention are set forth in the description which follows, and in part will become apparent from the description and the accompanying drawings, or may be learned by practice of the invention according to the teachings provided in the description. Objects as well as other features and advantages of the present invention will be realized and attained by a system, an apparatus, and a method for license management particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides a license management apparatus including a reception unit that receives identification data of a second license corresponding to a predetermined service, a search unit that searches for license data of a first license corresponding to a service matching the predetermined service, in a storage unit that stores license data including status data of each license, and a transmission unit that transmits a search result of the search by the search unit. The second license is a license that is not yet used and the first license is a license that is currently used.

Other objects, features and advantages of the present invention will become more apparent from the following detailed description when read in conjunction with the accompanying drawings.

### BRIEF DESCRIPTION OF THE DRAWINGS

FIG. 1 is a schematic diagram illustrating a configuration of a data process system according to an embodiment of the present invention;

FIG. 2 is a schematic diagram illustrating a hardware configuration of a service providing apparatus according to an embodiment of the present invention;

FIG. 3 is a schematic diagram illustrating a functional configuration of a service providing apparatus according to an embodiment of the present invention;

FIG. 4 is a schematic diagram illustrating a functional configuration of a contract data management apparatus according to an embodiment of the present invention;

FIG. 5 is a schematic diagram illustrating status transition of a license according to an embodiment of the present invention;

FIG. 6 is a schematic diagram illustrating a functional configuration of a license management unit according to an embodiment of the present invention;

FIG. 7 is a flowchart for describing processes performed when starting use of a license according to an embodiment of the present invention;

FIG. 8 is a schematic diagram illustrating a configuration of a contract data storage unit according to an embodiment of the present invention;

FIG. 9 is a schematic diagram illustrating a configuration of a license data storage unit according to an embodiment of the present invention;

FIG. 10 is a flowchart for describing processes performed in an operation of searching for a list of license data according to an embodiment of the present invention;

FIG. 11 is a schematic diagram illustrating an example where a license list screen is displayed according to an embodiment of the present invention;

FIG. 12 is a schematic diagram illustrating an example where a post-update designation screen is displayed according to an embodiment of the present invention;

FIG. 13 is a flowchart for describing processes of an operation for searching for candidate update licenses according to an embodiment of the present invention;

FIG. 14 is a schematic diagram illustrating an example where an update candidate list screen is displayed according to an embodiment of the present invention;

FIG. 15 is a flowchart for describing processes performed in a license update procedure according to an embodiment of the present invention;

FIG. 16 is a schematic diagram illustrating a configuration of a license data storage unit after performing an updating procedure according to an embodiment of the present invention;

FIG. 17 is a flowchart for describing an example of processes performed in accordance with expiration of a license period according to an embodiment of the present invention;

FIG. 18 is a flowchart for describing processes performed in accordance with a service use request according to an embodiment of the present invention;

FIG. 19 is a flowchart for describing processes performed when starting use of a license according to another embodiment of the present invention;

FIG. 20 is a schematic diagram illustrating a configuration of a contract data storage unit according to another embodiment of the present invention;

FIG. 21 is a schematic diagram illustrating a configuration of a license data storage unit according to another embodiment of the present invention;

FIG. 22 is a flowchart for describing processes performed in a license update procedure according to another embodiment of the present invention;

FIG. 23 is a schematic diagram illustrating a configuration of a license data storage unit after performing an updating procedure according to another embodiment of the present invention;

FIG. 24 is a flowchart for describing an example of processes performed in accordance with expiration of a license period according to another embodiment of the present invention; and

FIG. 25 is a flowchart for describing processes performed in accordance with a service use request according to another embodiment of the present invention.

### DETAILED DESCRIPTION OF THE PREFERRED EMBODIMENTS

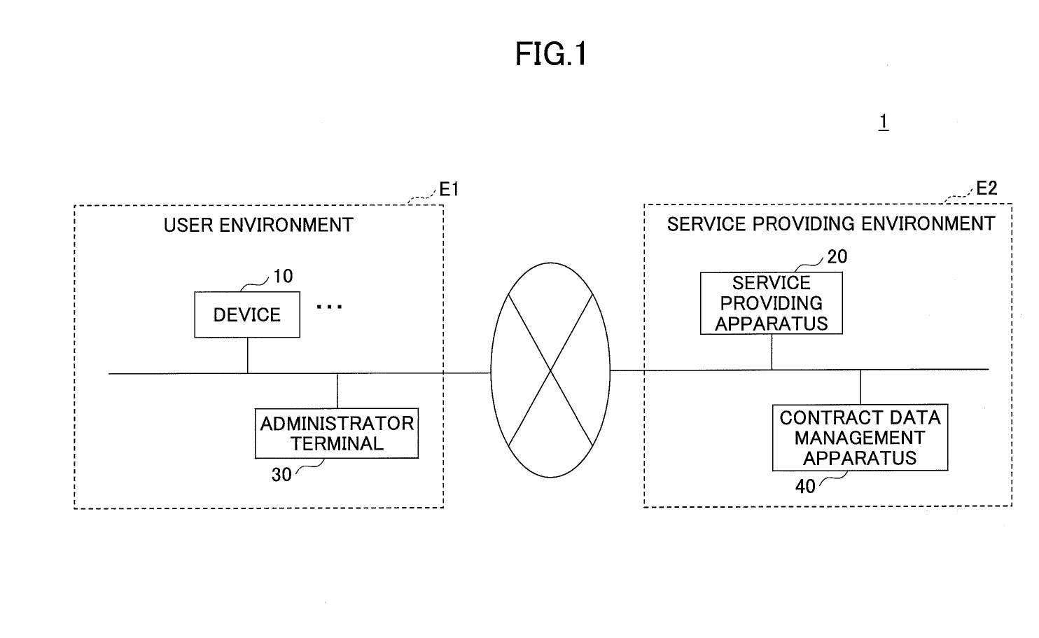

Next, embodiments of the present invention are described with reference to the accompanying drawings. FIG. 1 is a schematic diagram illustrating a configuration of a data process system 1 according to an embodiment of the present invention. The data process system 1 includes a user environment E1 and a service provider environment E2 that can communicate with each other by way of a wide area network (e.g., Ethernet).

The service provider environment E2 is a system environment of an organization that provides a cloud service by way of a network. Although this embodiment is described using an example of a cloud service, this embodiment may also be applied to other services provided by way of a network such as a service provided by an ASP (Application Service Provider) or a Web service.

The service provider environment E2 includes, for example, a service providing apparatus 20 and a contract data management apparatus 40. The service providing apparatus 20 and the contract data management apparatus 40 are connected to each other and can communicate by way of a network such as a LAN (Local Area Network) or a WAN (Wide Area Network).

The service providing apparatus 20 provides a predetermined service by way of a network. One type of service provided by the service providing apparatus 20 is a service implemented by the coordination between a device 10 in the user environment E1 and an application of the service providing apparatus 20. This type of service is hereinafter also referred to as “device coordination service”. One example of the device coordination service is a service referred to as a “Scan-to-Storage service” in which an application of the service providing apparatus 20 stores image data scanned by the device 10 in the user environment E1 to a storage destination that is set (designated) beforehand. The device coordination service may coordinate with, for example, a service (e.g., online storage, other cloud services) provided by another service provider by way of a network. The other service provider is a service provider besides a service provider in the service provider environment E2.

The service providing apparatus 20 also includes a management function for managing a license(s) of the device coordination service. The license of the device coordination service is authority to use the device coordination service. That is, in order for the user to use the device coordination service, the user is required to purchase a license corresponding to the device coordination service beforehand.

The contract data management apparatus 40 manages contract data. The contract data is data pertaining to a usage contract between a user (licensee) and a distributor of the license of the device coordination service (licensor). The usage contract between the user and the distributor pertains to the use of the device coordination service. The usage contract pertaining to the use of the device coordination service may take effect when, for example, the license is sold. Although described in further detail below, data such as contents of a license are included in the contract data.

It is to be noted that the functions of the service providing apparatus (also referred to as “license apparatus”) 20 and the contract data management apparatus 40 may be implemented by using the same computer.

The user environment E1 is a system environment of the device 10 of an organization (e.g., user's company). In the user environment E1, one or more devices 10 are connected to an administrator terminal 30 by way of a network (e.g., LAN (Local Area Network)).

The device 10 is a device (apparatus) serving as a candidate to be used for device coordination (coordination candidate) with respect to the device coordination service. The administrator terminal 30 is a terminal used by an administrator of the device 10 in the user environment E1. For example, the administrator terminal 30 may be a PC (Personal Computer), a PDA (Personal Digital Assistance), a tablet type terminal, a smart-phone, or a mobile phone.

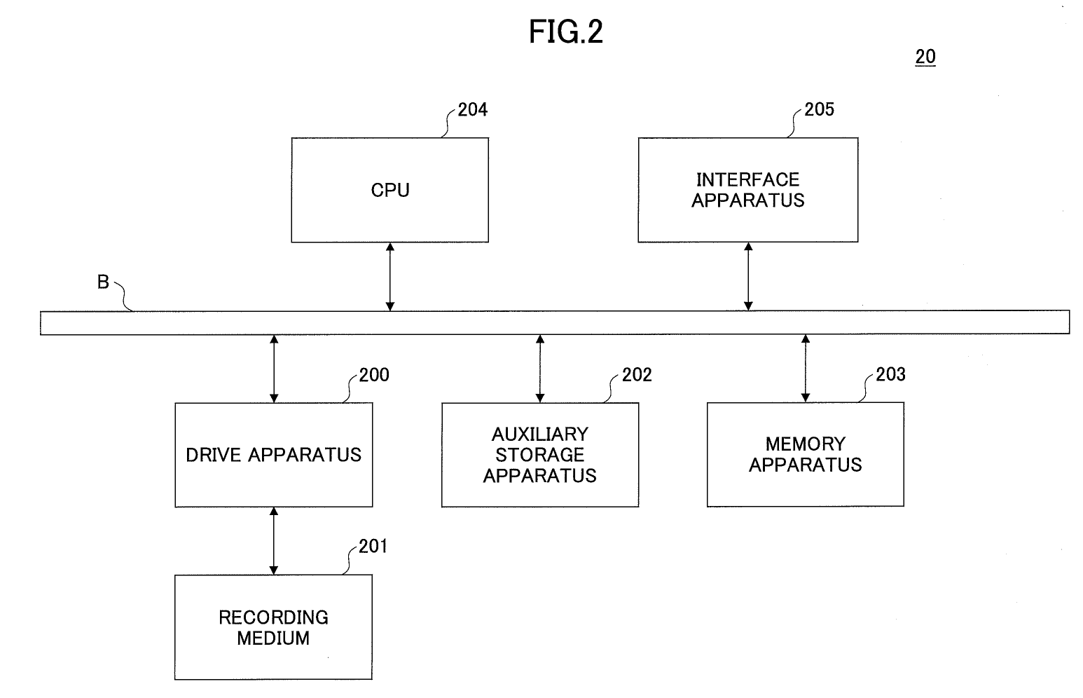

FIG. 2 is a schematic diagram illustrating a hardware configuration of the service providing apparatus 20 according to an embodiment of the present invention. The service providing apparatus 20 of FIG. 2 includes a drive apparatus 200, an auxiliary storage apparatus 202, a memory apparatus 203, a CPU 204, and an interface apparatus 205 that are connected to each other by a bus B.

A program that implements the processes of the service providing apparatus 20 may be recorded in a recording medium (e.g., CD-ROM) 201 and provided by way of the recording medium 201. The program recorded in the recording medium 201 is installed in the auxiliary storage apparatus 202 via the drive apparatus 200 by setting the recording medium 201 to the drive apparatus 200. It is, however, to be noted that the program does not necessarily need to be installed from the recording medium 201. For example, the program may be downloaded with a computer via a network. In addition to storing the installed program, the auxiliary storage apparatus 202 may also store necessary files and data.

In a case where activation of the program is instructed, the memory apparatus 203 reads out the program from the auxiliary storage apparatus 202 and loads (stores) the program therein. The CPU 204 executes functions of the service providing apparatus 20 in accordance with the program stored in the memory apparatus 203. An interface apparatus 205 is an interface used for connecting the service providing apparatus 20 to a network.

The service providing apparatus 20 may be constituted by multiple computers having the hardware configuration illustrated in FIG. 2. In other words, the below-described processes performed by the service providing apparatus 20 may be deployed to and executed by the multiple computers. Similar to the service providing apparatus 20, the contract data management apparatus 40 may also be constituted by multiple computers having the hardware configuration illustrated in FIG. 2.

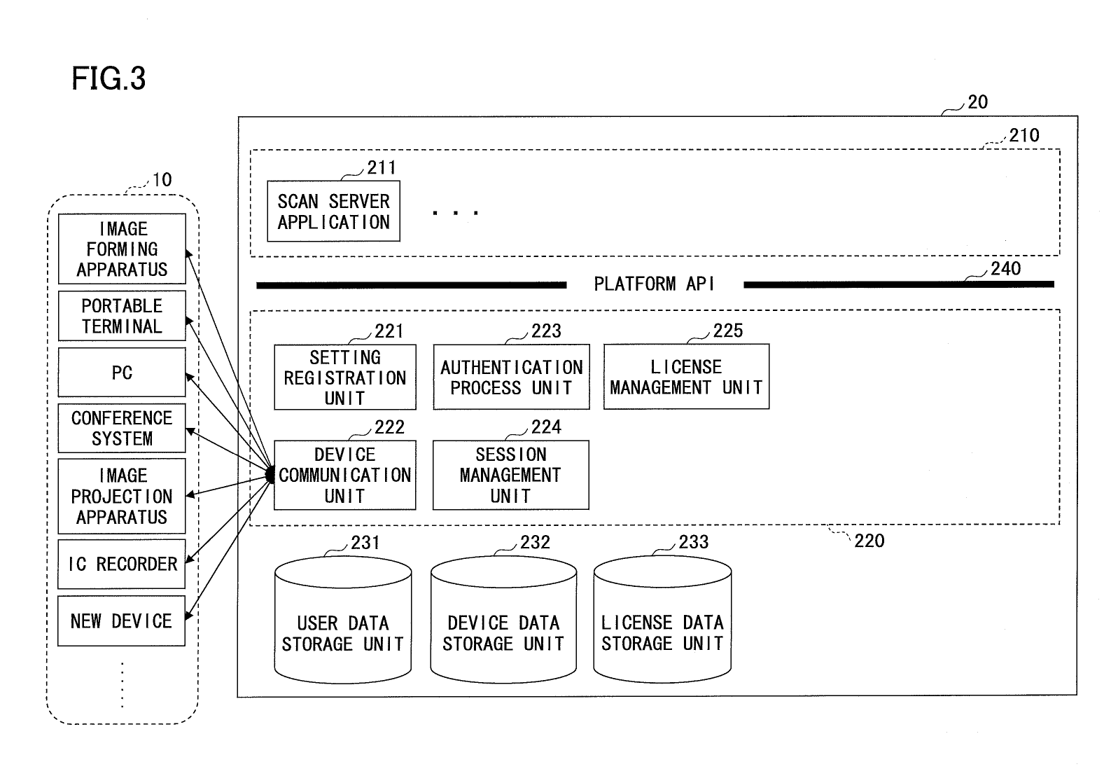

FIG. 3 is a schematic diagram illustrating a functional configuration of the service providing apparatus 20 according to an embodiment of the present invention. In FIG. 3, the service providing apparatus 20 includes software such as a server application 210 and a platform 220. The server application 210 and the platform 220 are constituted by one or more programs installed in the service providing apparatus 20 and executed to performed predetermined processes by way of the CPU 204.

The service providing apparatus 20 also uses, for example, a user data storage unit 231, a device data storage unit 232, and a license data storage unit 233. These storage units 231-233 may be implemented by way of the auxiliary storage apparatus 202 or a storage apparatus connected to the service providing apparatus 20 via a network.

The server application 210 is an application program that is used for implementing the device coordination service provided by the service providing apparatus 20. Basically, a single server application 210 corresponds to a single device coordination service. Thus, a license of a device coordination service is basically a license of the server application 210 corresponding to the device coordination service.

In FIG. 3, a scan server application 211 is illustrated as one example of the server application 210. The scan server application 210 executes a process pertaining to a Scan-to-Storage service.

The platform 220 includes, for example, a function that multiple server applications 210 commonly have or a basic function that is used by multiple server applications 210. In FIG. 3, the platform 220 includes, for example, a setting registration unit 221, a device communication unit 222, an authentication process unit 222, a session management unit 224, and a license management unit 225. The functions of these units 221-225 are disclosed to the server application 210 by way of the platform API 240. In other words, the server application 210 can use the functions of these units 221-225 to the extent disclosed by the platform API 240.

The setting registration unit 221 executes a process of registering data settings pertaining to the user environment E1 (setting registration process). The setting registration process is to be performed prior to the use of the device coordination service. The setting registration unit 221 registers data to, for example, user data storage unit 231 and the device data storage unit 232.

The user data storage unit 231 stores data pertaining to the user that uses the service provided by the service providing apparatus 20. The device data storage unit 232 stores data pertaining to the device 10 of the user environment E1 (i.e. system environment of the user) that is to coordinate with the service provided by the service providing apparatus 20.

The device communication unit 222 controls communications of the service providing apparatus 20 with the device 10. The authentication process unit 223 authenticates, for example, a user of the administrator terminal 30 or a user of the device 10. The session management unit 224 manages sessions of communications between the service providing apparatus 20 and the device 10 during device coordination.

The license management unit 225 performs, for example, registration of license data to the license data storage unit 233 and/or updating of license data stored in the license data storage unit 233 according to the use of the license by the user. Further, the license management unit 225 may also perform, for example, searching of license data stored in the license data storage unit 233. The license management unit 225 may perform the registration of license data or the updating of the license data, so that the corresponding relationship between a license and contract data corresponding to the license can clearly distinguished.

The license data storage unit 233 stores license data of a license that the user has started to use in the device coordination service. It is to be noted that the term “a license that the user has started to use” includes a license whose use has been terminated (i.e. license whose validity period has expired).

In FIG. 3, an image forming apparatus (e.g., a multifunction apparatus, a copier, a facsimile, a facsimile, a printer), a portable terminal, a PC, a conference system, an image projection apparatus, an IC recorder, or a new device are illustrated as examples of the device 10.

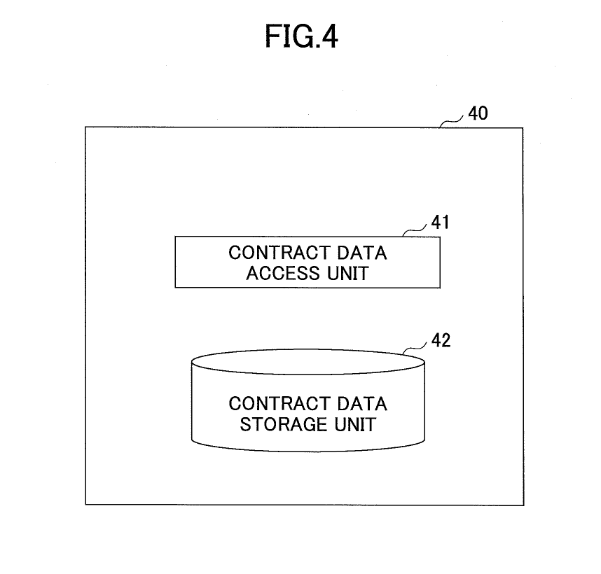

FIG. 4 is a schematic diagram illustrating a functional configuration of the contract data management apparatus 40 according to an embodiment of the present invention. In FIG. 4, the contract data management apparatus 40 includes, for example, a contract data access unit 41 and a contract data storage unit 42.

The contract data storage unit 42 stores contract data. The contract data storage unit 42 may be implemented by, for example, an auxiliary storage unit included in the contract data management apparatus 40 or a storage apparatus connected to the contract data management apparatus 40 via a network. The contract data access unit 41 serves as a unit for accessing the contract data storage unit 42.

The contract data stored in the contract data storage unit 42 is generated in correspondence with a conclusion of a usage contract (purchase of a license) of the device coordination service. The license data stored in the license data storage unit 223 is generated in correspondence with the start of use of a license that has been purchased.

Next, status transition pertaining to a license of a device coordination service according to an embodiment of the present invention is described.

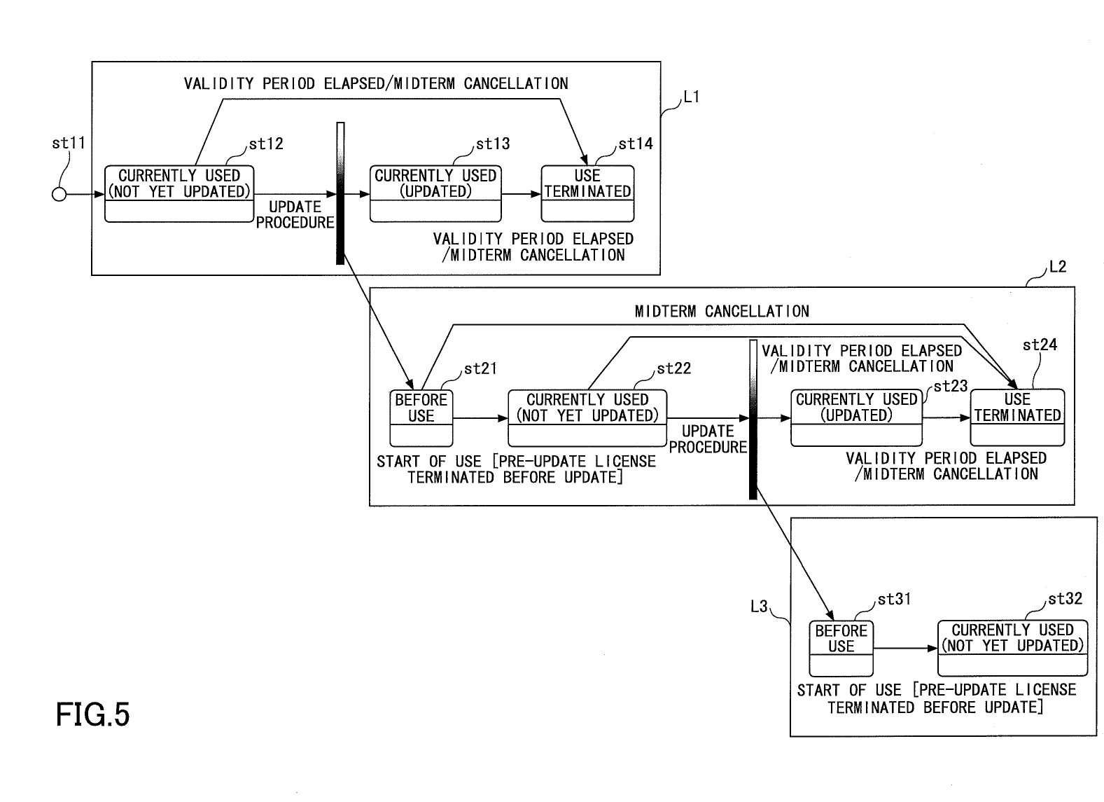

FIG. 5 is a schematic diagram illustrating status transition of a license according to an embodiment of the present invention. In FIG. 5, status transitions of three licenses L1-L3 are illustrated. The licenses L1-L3 are licenses that are purchased with respect to the same device coordination service (in this embodiment, “service A”). In other words, contract data of each of the licenses L1-L3 are managed by the contract data management apparatus 40. In this embodiment, the user that has purchased the licenses L1-L3 is referred to as “user A”.

When the user A starts to use the license L1, the status of the license L1 makes a transition from an “initial” status st11 to a “currently used (not yet updated)” status st12. The “initial” status st11 indicates that a license is not yet used by the user but already has its contract data managed by the contract data management apparatus 40. In other words, according to this embodiment, even if a validity period of a license is included in the contract data, the user may arbitrarily decide the timing of starting the use of the license (e.g., timing of the start of a validity period). The start of use of the license is a status where the device coordination service (to which authorization is granted by the license) becomes usable.

Further, the term “not yet updated” of the “currently used (not yet updated)” status indicates that the license has not yet been updated (i.e. no past record of the license being updated). In this embodiment, updating of a license refers to updating of a validity period of a license. More specifically, updating a license refers to substantially extending a validity period of a license.

In a case where the user A desires to continue the use of the service A (to which authorization is granted by the license L1) after the validity period of the license L1, the user A may perform an updating procedure for the license L1 during the validity period of the license L1 (i.e. performing a procedure to update a license while the validity period of the license has not yet expired). During the updating procedure, the user A designates a license to be applied to the service A after the expiration of the validity period of the license L1. In FIG. 5, the license L2 is illustrated as an example of the license designated the license to be applied to the service A after the expiration of the validity period of the license L1 (post-update license). The license L2 is a license that is purchased independently from the license L1. The license L2 and the license L1 can be used separately. However, the license L2 can also be used as an updated license of the license L1. That is, in this embodiment, at least one of the licenses L1-L3 can be used as an updated license of another one of the license L1-L3 corresponding to the same device coordination service. Therefore, instead of designating the license L2, it is possible for the license L3 to be designated as a “post-update license” corresponding to the license L1. In terms of the relationship between the license L1 and the license L2 according to the embodiment of FIG. 5, the license L1 is a “pre-update license” corresponding to the license L2 (license before update of license L2) whereas the license L2 is a “post-update license” corresponding to the license L1 (license after update of license L1).

It is to be noted that the phrase “the license L2 and the license L1 can be used separately” not only refers to a case of using the license L2 as a post-update license of the license L1 but also to a case of using the license L2 during a period where the validity period of the license L1 and the validity period of the license L2 overlap each other. The phrase “the license L2 and the license L1 can be used separately” may also refer to a case of using the license L2 some period after the expiration of the validity period of the license L1 for receiving the service A. For example, in a case where each license regulates that the number of users that can use the service A at the same time is 1 (one user), the license L2 may be used during a period where the validity period of the license L2 overlaps the validity period of the license L1, so that two users can use the service A at the same time.

In accordance with the updating procedure by the user A, the license L1 (which is the “pre-update license”) makes a transition to “currently used (updated)” status st13. Similar to the license L1 having the “currently used (not yet updated)” status st12, the license L1 having the “currently used (updated)” status st13 is also in a usable state. However, the license L1 having the “currently used (updated)” status st13 is different from the license L1 having the “currently used (not yet updated)” status st12 in that the updating procedure has been performed for the license L1. In this embodiment, the license L1 is distinguished depending on whether the license has the “currently used (not yet updated)” status st12 or the “currently used (updated)” status st13 because the updating procedure can only be performed one time with respect to a single license. The advantages that can be attained by limiting the number of times of performing the updating procedure to a single time are described below.

On the other hand, in accordance with the updating procedure by the user A, the license L2 (which is the “post-update license” corresponding to the license L1) makes a transition to a “before use” status st21. A license having a “before use” status st21 refers to a license that is not yet used but is reserved to be used in accordance with expiration of a validity period of a pre-update license corresponding to the license.

When the validity period of the license L1 expires, the license L1 makes a transition to a “use terminated” status st14. Further, the license L2 makes a transition to a “currently used (not yet updated)” status st22 in accordance with the expiration of the validity period of the license L1. As a result, the user A can continue to use the service A based on the license L2.

In a case where the user A desires to continue the use of the service A after the expiration of the validity period of the license L2, the user A may perform an updating procedure for the license L2 during the validity period of the license L2. In FIG. 5, the license L3 is illustrated as an example of the license designated as the post-update license corresponding to license L2. The relationship between the license L2 and the license L3 of the embodiment of FIG. 5 is the same as the relationship between the license L1 and the license L2. That is, the license L2 is a “pre-update license” corresponding to the license L3 (license before update of license L3) and the license L3 is an “post-update license” corresponding to the license L2 (license after update of license L2).

In accordance with the updating procedure by the user A, the license L2 makes a transition to a “currently used (updated)” status st23. Further, the license L3 makes a transition to a “before use” status st31. Then, after the validity period of the license L2 expires, the license L2 makes a transition to a “use terminated” status st24. Further, the license L3 makes a transition to a “currently used (not yet updated)” status st32.

Hence, according to the above-described embodiment, instead of updating an expiration date of a validity period of a license, a validity period of a license can be substantially updated (extended) by chaining together licenses that are independent from each other. By doing so, relationships between licenses and corresponding contract data can be associated to each other on a one-on-one basis. That is, the corresponding relationships between contract data of the licenses L1, L2, L3 and the licenses L1, L2, L3 can be prevented from becoming indistinct with one another.

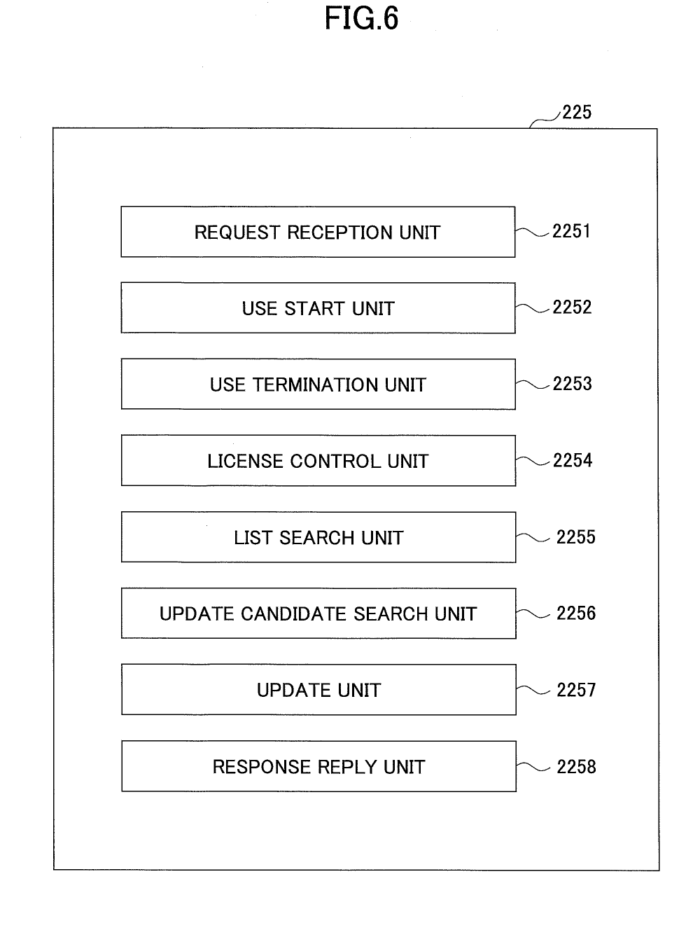

Next, the license management unit 225 is described in further detail. FIG. 6 is a schematic diagram illustrating a functional configuration of the license management unit 225 according to an embodiment of the present invention. In FIG. 6, the license management unit 225 includes, for example, a request reception unit 2251, a use start unit 2252, a use termination unit 2253, a license control unit 2254, a list search unit 2255, an update candidate search unit 2256, an update unit 2257, and a response reply unit 2258.

The request reception unit 2251 receives, for example, a request pertaining to manipulation or management of a license. The request may be transmitted from, for example, the administrator terminal 30. In a case where the start of use of a license is requested, the use start unit 2252 renders a license to become a usable state. The usable state corresponds to the “currently used” status of a license. The use termination unit 2253 renders a license having an expired validity period to become an unusable state (or invalid state). In response to a request to use the device coordination service, the license control unit 2254 determines whether to allow the use of the device coordination service based on, for example, the existence of a license corresponding to the device coordination service.

The list search unit 2255 searches through the license data storage unit 233 to acquire a list of license data corresponding to a user(s). In response to a search request specifying a post-update license, the update candidate search unit 2256 searches through the license data storage unit 233 to acquire license data of a license that can be updated by the specified post-update license (i.e. a license that qualifies as a pre-update license corresponding to the specified post-update license). The update unit 2257 performs updating of a license. The response reply unit 2258 transmits a reply in response to a request received by the request reception unit 2251.

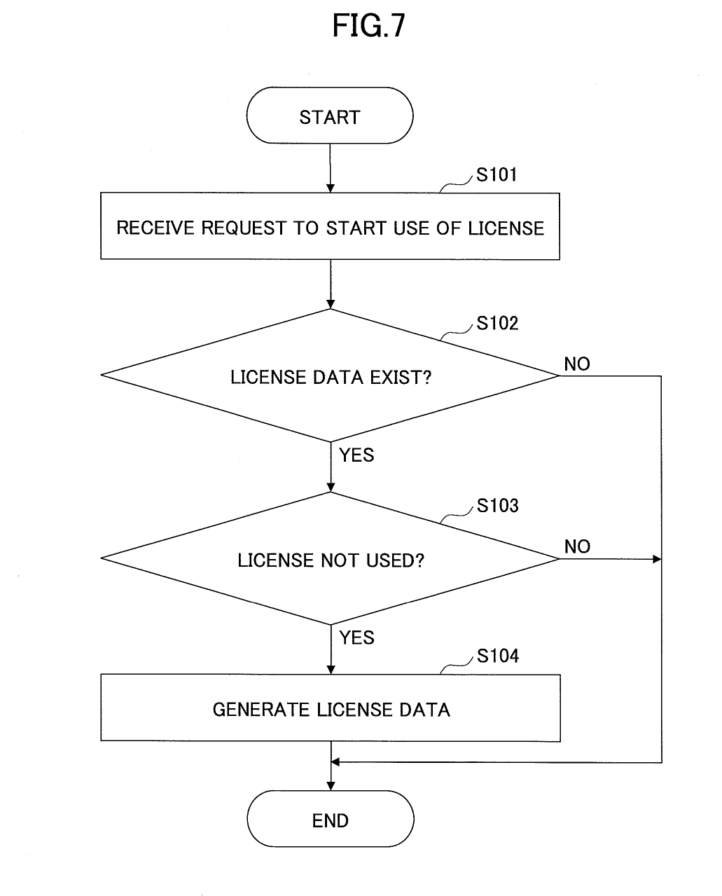

Next, processes performed by the service providing apparatus 20 according to an embodiment of the present invention are described. FIG. 7 is a flowchart for describing processes performed when starting the use of a license. For example, the processes illustrated in FIG. 7 are performed when starting the use of a license that is not a post-update license (e.g., license L1 of FIG. 5).

In Step S101, the request reception unit 2251 of the license management unit 225 receives a request to start use of a license (license use start request) from the administrator terminal 30. For example, the license use start request is transmitted from the administrator terminal 30 to the service providing apparatus 20 in accordance with instructions input by an administrator. A license ID (identification data) of a license to be used (target license), a device number of the device 10 that is to use the target license, and identification data of a user that is to use the license are designated with the license use start request. In this embodiment, an organization ID serves as the identification data of the user that is to use the license. The organization ID is identification data of an organization including the user environment E1. For example, the organization ID may be identification data that identifies a company or a section or department of the company. The organization ID may also be identification data corresponding to a group of multiple users. Further, before receiving the license use start request, an authentication process may be performed on the user. In a case where an organization ID is designated during the authentication process, the license use start request need not include a designation of the organization ID.

Further, the device number of the device 10 (that is to use the target license) is identification data of the device 10 that is to use the device coordination service according to the target license. That is, in this embodiment, a license of the device coordination service is associated with a corresponding device 10. In other words, a single license allows only a single device 10 to use the device coordination service. As long as the device 10 can be distinguished from another device 10, the device number is not limited to particular data. For example, the device number of the device 10 may be a product number of the device 10 or a MAC address of the device 10.

The license ID, the device number, the organization ID that are designated with the license use start request may hereinafter be referred to as “target license ID”, “target device number”, and “target organization ID”.

Then, the use start unit 2252 of the license management unit 225 determines whether contract data corresponding to the target organization ID and the target license ID exist by way of the contract data access unit 41 of the contract data management unit (Step S102). The existence of contract data is determined by determining whether corresponding contract data is stored in the contract data storage unit 42.

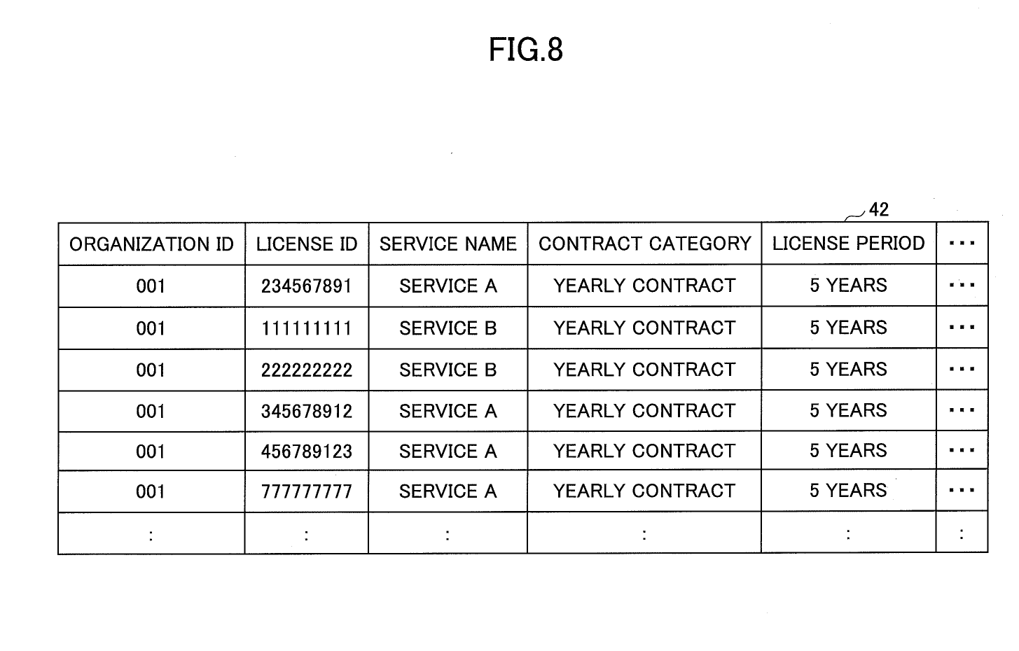

FIG. 8 is a schematic diagram illustrating a configuration of the contract data storage unit 42 according to an embodiment of the present invention. In FIG. 8, the contract data storage unit 42 stores a record indicating contract data in correspondence with each contract to use the device coordination service (usage contract). The contract data includes, for example, an organization ID, a license ID, a service name, a contract category, and a license period.

The organization ID is an organization ID of a user agreeing to the usage contract. The license ID is a license ID of a license purchased according to the usage contract. The service name is an identification name of the device coordination service subjected to the usage contract. The contract category is a category for indicating the method for updating a license purchased according to the usage contract. In this embodiment, “contract category” includes, for example, “yearly contract” and “automatic update”. The contract category “yearly contract” indicates that an updating procedure is to be performed on a yearly basis. The contract category “automatic update” indicates that a validity period of a license is automatically updated. In other words, “automatic update” means that the validity period of the license is indefinite. The license period is a validity period of a license purchased according to the usage contract.

In a case where contract data including both the target organization ID and the target license ID (hereinafter also referred to as “target contract data”) exists (Yes in Step S102), the use start unit 2252 determines whether the license corresponding to the target contract data is already being used (Step S103). The determination of the use of the license corresponding to the contract data may be performed by, for example, referring to the license data storage unit 233.

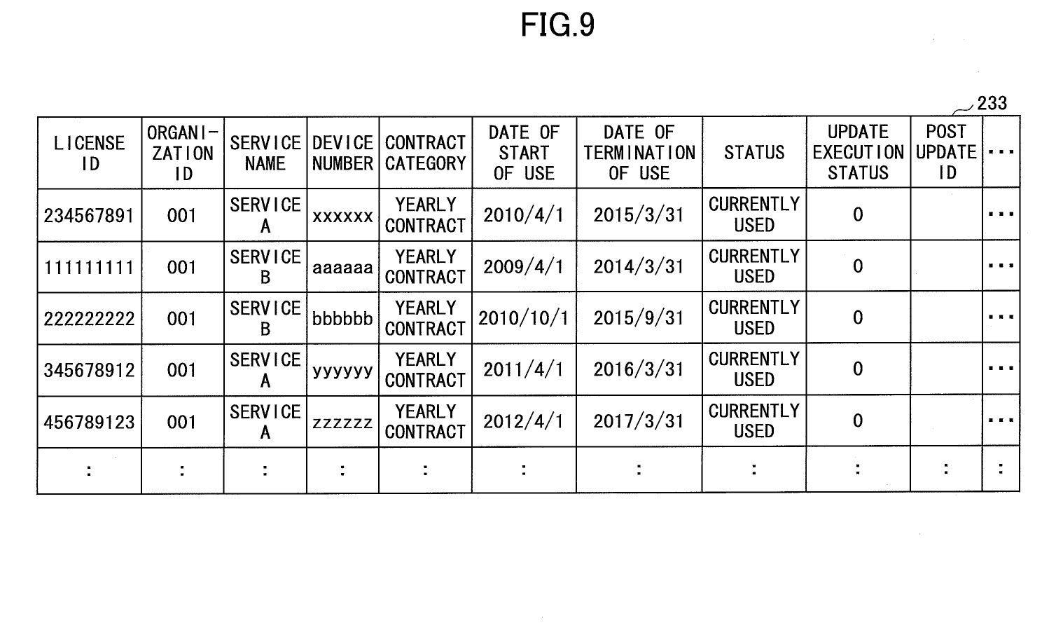

FIG. 9 is a schematic diagram illustrating a configuration of the license data storage unit 233 according to an embodiment of the present invention. The license data storage unit 233 of FIG. 9 stores records indicating license data in correspondence with each license which has already started to be used. The license data includes, for example, a license ID, an organization ID, a service name, a device number, a contract category, a date of start of use, a date of termination of use, a status, an update execution status, and an ID after update (post-update ID).

The “license ID” indicates an ID of a license. The “organization ID” indicates an organization ID of a user that has purchased the license. The “service name” indicates a service name of a device coordination service to be used with the license. The “device number” indicates a device number of the device that can use (allowed to use) the device coordination service. The “contract category” indicates a contract category of the license. The “date of start of use” indicates the date of the start of the validity period of the license. The “date of termination of use” indicates the date of the end of the validity period of the license. The “status” indicates the status of the license (i.e. transition of statuses illustrated in FIG. 5). The “update execution status” indicates whether there is a past record of performing an updating procedure on the license. For example, in a case where the “update execution status” is “1”, an updating procedure has been performed on the license. In a case where the “update execution status” is “0”, an updating procedure has not been performed on the license. In other words, the “update execution status” serves an item for distinguishing whether the status of the license is “currently used (not yet updated)” or “currently used (updated)” as illustrated in FIG. 5. The “post-update ID” indicates a license ID of a post-update license corresponding to a license on which an updating procedure has been performed. For example, in the embodiment of FIG. 5, the post-update ID of the license L1 would be the license ID of the license L2. Further, the post-update ID of the license L2 would be the license ID of the license L3.

Further, in Step S103, it is determined whether a record including both the target license ID and the target organization ID is stored in the license data storage unit 233.

In a case where a recording including both the target license ID and the target organization ID is not stored in the license data storage unit 233 (Yes in Step S103), the use start unit 2252 generates license data corresponding to the license ID and registers the generated license data to the license data storage unit 233 (Step S104). For example, in a case where the target contract data corresponds to the contract data in rows 1-5 of the contract data storage unit 42 of FIG. 8, the records (license data) of rows 1-5 in the license data storage unit 233 of FIG. 9 would be the license data recorded to the license data storage unit 233 in Step S104. It is, however, to be noted that the timing of registering each of the license data to the license data storage unit 233 is different. For example, each of the license data is registered to the license data storage unit 233 in correspondence with the “date of start of use” in each of the license data.

The values included in the target contract data are copied (stored) in the license ID, the organization ID, the service ID, the service name, and the contract category of the records. The date of receiving the license use start request is stored in the “date of start of use” of a corresponding record of the license data storage unit 233. Alternatively, a specific date may be designated as “date of start of use” by the license use start request. In this case, the specific date designated in the license use start request may be stored in the “date of start of use” of a corresponding record of the license data storage unit 233.

The last day of the license period included in the contract data is stored in the “date of termination of use” of a corresponding record of the license data storage unit 233 where the “date of start of use” of the record is the starting point of the license period. The target device number is stored in the “device number” of a corresponding record of the license data storage unit 233. The status “currently used” is stored in the “status” of a corresponding record of the license data storage unit 233. The numeral “0” is stored in the “update execution status” of a corresponding record of the license data storage unit 233. Because the updating procedure has not yet been performed on the license of the record (license data) registered in Step S104, no data is stored in the “post-update ID” of a corresponding record of the license data storage unit 233.

In a case where the target contract data is not stored in the contract data storage unit 42 (No in Step S102) or where license data corresponding to the target contract data is stored in the license data storage unit 233 (No in Step S103), the license use start request is denied.

Next, the processes performed by the license providing apparatus 20 in a case of performing an updating procedure on a currently used license are described.

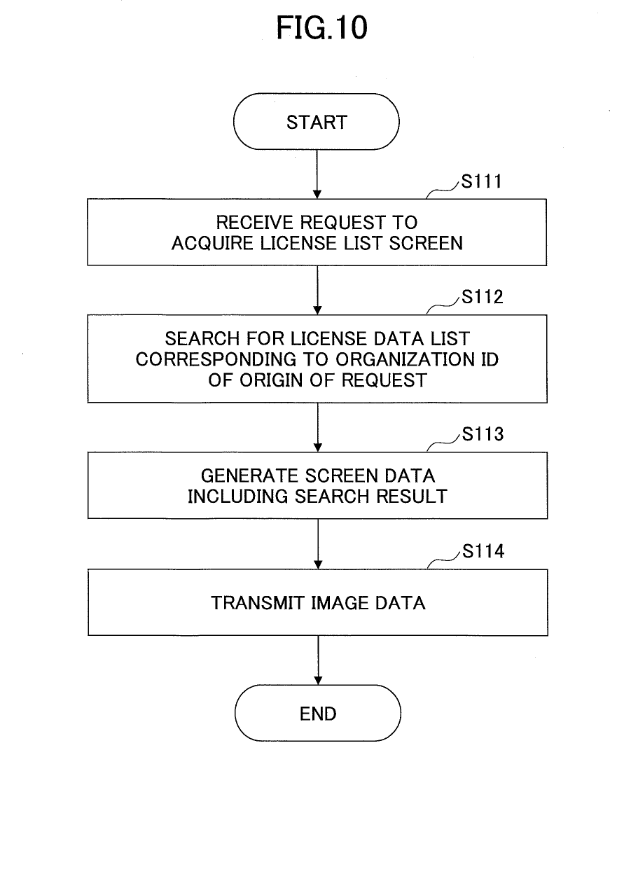

FIG. 10 is a flowchart for describing processes performed in an operation of searching for a list of license data.

In Step S111, the request reception unit 2251 of the license management unit 225 receives a request to acquire a license list screen from the administrator terminal 30 (license list screen acquirement request). For example, the license list screen acquirement request is transmitted from the administrator terminal 30 to the service providing apparatus 20 in accordance with instructions input by an administrator. An organization ID of the user requesting the acquirement of the license list screen (i.e. origin of the license list screen acquirement request) is designated with the license list screen request. Before receiving the license list screen request, an authentication process may be performed on the user. In a case where an organization ID is designated during the authentication process, the license list screen request need not include a designation of the organization ID.

Then, the list search unit 2255 searches through the license data storage unit 233 and acquires a list of license data including the organization ID designated in the license list screen acquirement request (Step S112). Then, the list search unit 2255 generates screen data to be displayed in the license list screen including the results of the search (Step S113). The screen data may be generated in a general purpose data format (e.g., HTML (HyperText Markup Language) or in a unique data format. In a case where the unique data format is used to generate the screen data, a browser or the like corresponding to the unique data format may be installed in the administrator terminal 30.

Then, the response reply unit 2258 transmits a reply including the generated screen data in response to the license list screen acquirement request. Then, the administrator terminal 30 displays a license list screen based on the screen data transmitted from the response reply unit 2258.

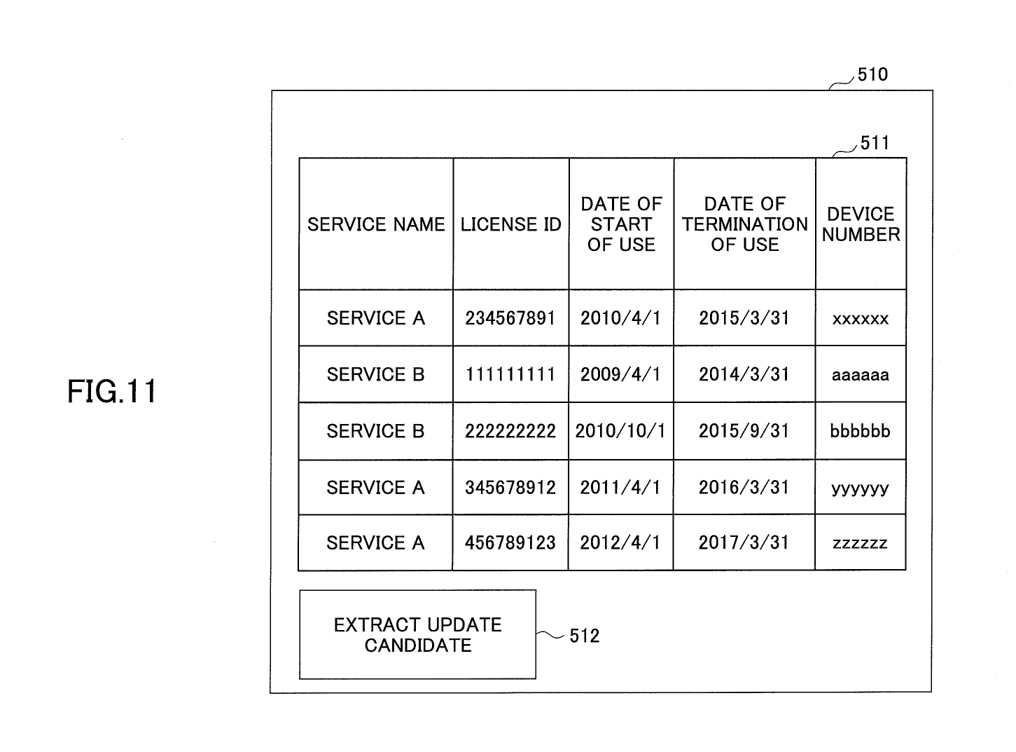

FIG. 11 is a schematic diagram illustrating an example where the license list screen is displayed according to an embodiment of the present invention. In FIG. 11, the license list screen 510 includes, for example, a license data list display area 511 and a button 512.

The list of license data acquired in Step S112 is displayed in the license data list display area 511. In the example of FIG. 11, although a portion of the items constituting the license data is displayed in the license data list display area 511, all of the items constituting the license data may be displayed in the license data list display area 511.

The license data displayed in the license data list display area 511 corresponds to the license data stored in the license data storage unit 233. Further, the license data stored in the license data storage unit 233 is license data that has started to be used. Therefore, the license data displayed in the license list display area 511 is a list including currently used licenses and/or terminated licenses of the organization to which the administrator belongs.

In a case where unused (not yet used) licenses are to be designated as post-update licenses, the button 512 serves a button for receiving an instruction to search and acquire license data of licenses to be updated (i.e. candidates of pre-update licenses corresponding to the post-update licenses). For example, in a case where the button 512 is pressed, the administrator terminal 30 displays a screen for designating post-update licenses.

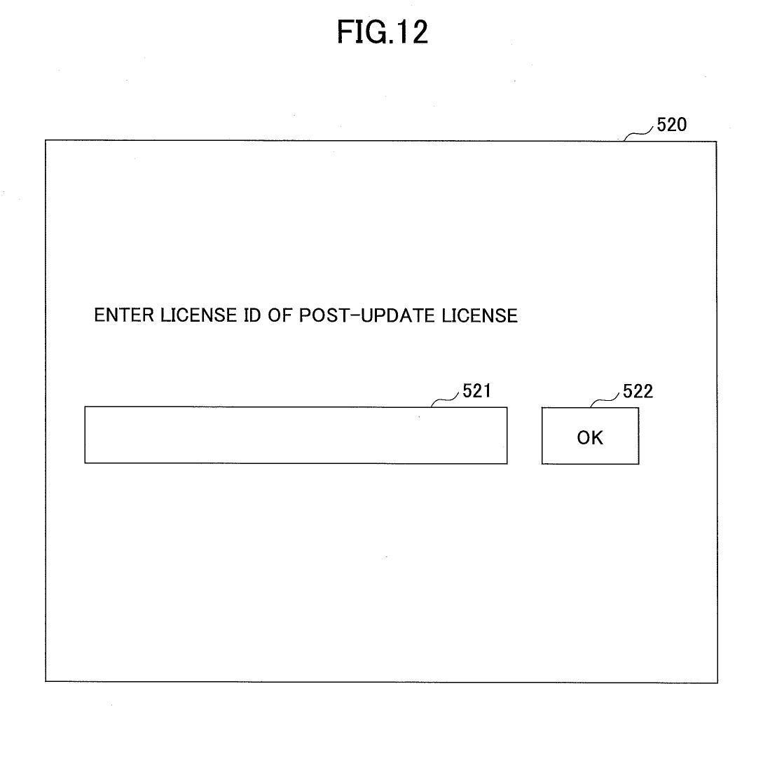

FIG. 12 is a schematic diagram illustrating an example where a post-update designation screen 520 is displayed according to an embodiment of the present invention. In FIG. 12, the post-update license designation screen 520 includes, for example, a license ID input area 521 and a button 522.

The license ID input area 521 is an area for accepting input of a license ID of a post-update license. That is, the administrator inputs a license ID of a license desired to be used as a post-update license corresponding to one of the currently used licenses into the license ID input area 521. Then, after the “OK” button is pressed by the administrator, the administrator terminal 30 transmits a request to search for candidate update licenses (candidate search request). The candidate update licenses are candidates of becoming pre-update licenses corresponding to the license having the license ID input into the license ID input area 521. An organization ID of the organization to which the administrator terminal 30 belongs and a license ID input to the license input area 521 are designated with the search request. Before receiving the search request, an authentication process may be performed on the user. In a case where an organization ID is designated during the authentication process, the search request need not include a designation of the organization ID.

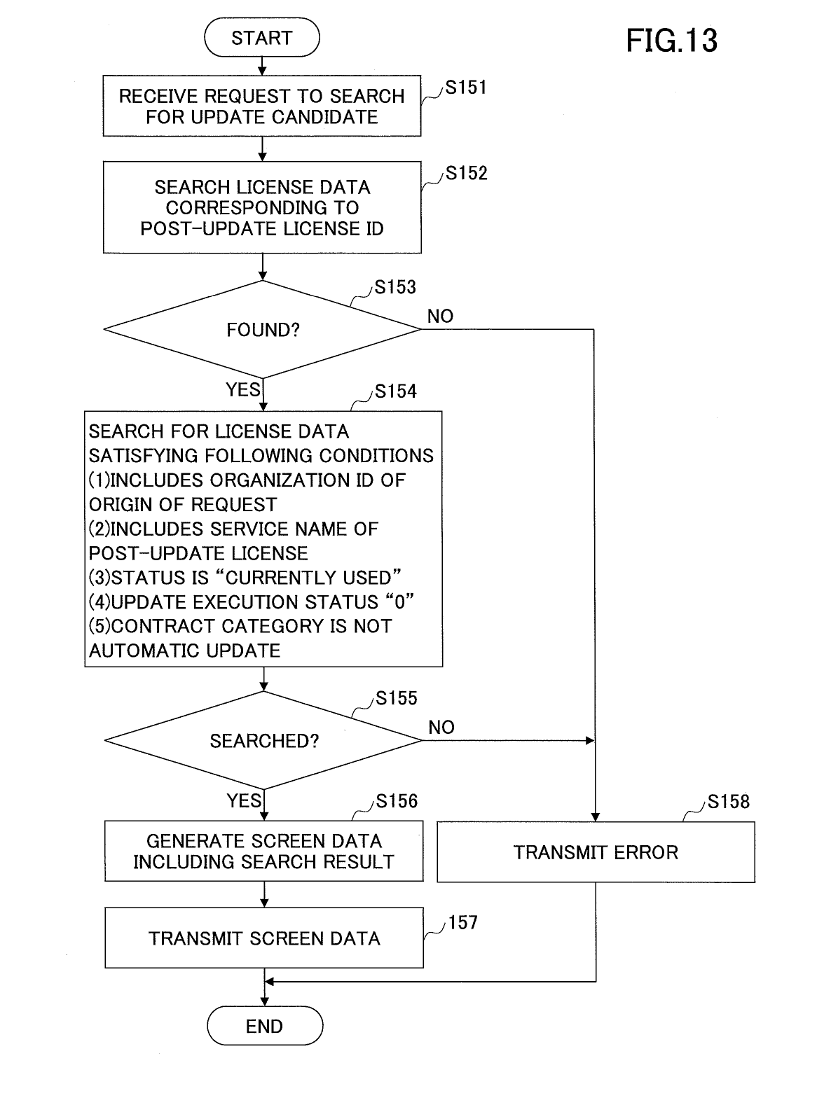

Next, processes performed by the service providing apparatus 20 in a case of responding to the candidate search request are described. FIG. 13 is a flowchart for describing processes of an operation for searching for candidate update licenses.

In Step S151, the request reception unit 2251 of the license management unit 225 receives a candidate search request. Then, in Step S152, the update candidate search unit 2256 of the license management unit 225 searches the contract data storage unit 42 (FIG. 8) by way of the contract data access unit 41 to acquire contract data including the license ID designated in the candidate search request (hereinafter also referred to as “post-update license ID”). In this embodiment, it is assumed that a post-update ID of “777777777” is designated in the candidate search request. Therefore, according to FIG. 8, contract data stored in the record of the 6^{th} row of the contract data storage unit 42 is searched. In a case where corresponding contract data is found by the search (Yes in Step S153), the update candidate search unit 2256 further searches through the license data storage unit 233 to acquire license data satisfying all of the following conditions. That is, the following conditions (1)-(5) tied together by “AND”.
(1) Including the organization ID designated in the candidate search request (i.e. organization ID of origin of candidate search request);
(2) Including a service name included in the contract data found according to the post-update license ID;

0(3) Having a status “currently used”;
(4) Having a an update execution status “0”; and
(5) Not having a contract category “automatic update” (because the update procedure would not be required if the contract category is automatic update).

In a case where corresponding license data is found (Yes in Step S155), the update candidate search unit 2256 generates screen data used for displaying an update candidate list screen 530 including the results of the search (Step S156). Then, the response replay unit 2258 transmits a reply including the generated screen data to the administrator terminal 30 (Step S157).

On the other hand, in a case where corresponding contract data is not found (No in Step S153) or a case where corresponding license data is not found (No in Step S155), the response replay unit 2258 transmits error data to the administrator terminal 30 (Step 158).

In a case where the administrator terminal 30 receives the screen data transmitted in Step S157, the administrator terminal 30 displays the update candidate list screen 530 based on the received screen data.

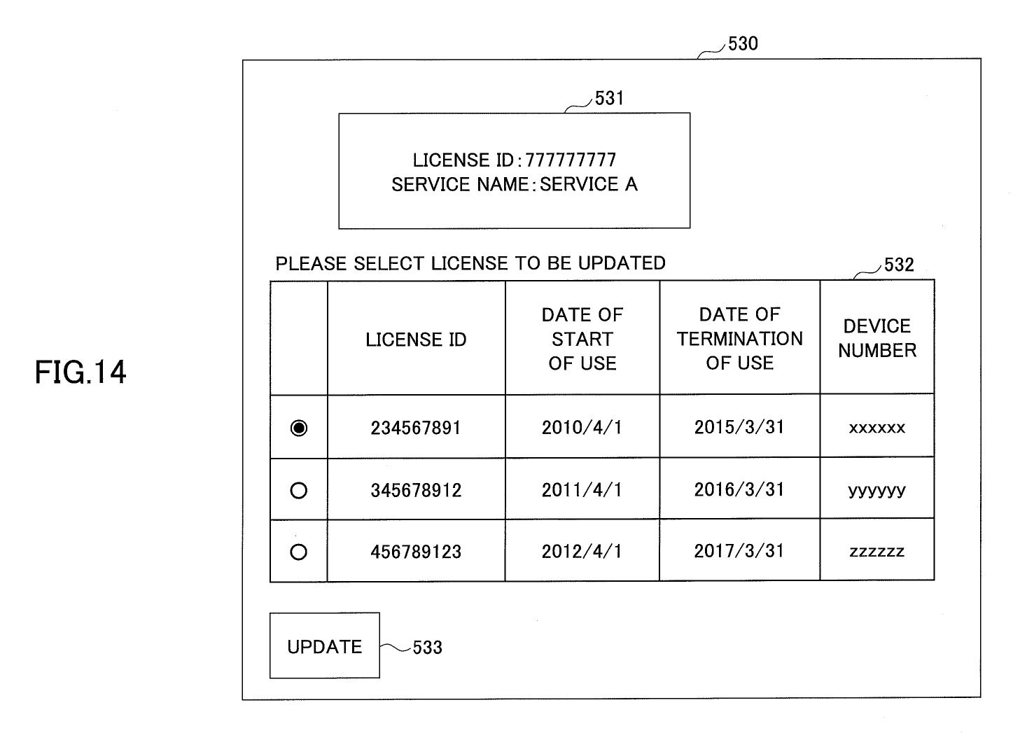

FIG. 14 is a schematic diagram illustrating an example where the update candidate list screen 530 is displayed according to an embodiment of the present invention. In FIG. 14, the update candidate list screen 530 includes, for example, a post-update license data display area 531, an update candidate list display area 532, and a button 533.

A portion of contract data corresponding to the post-update license ID found in Step S153 is displayed in the post-update license data display area 531. A list of license data of candidate update licenses (candidate licenses to be updated) found in Step S155 is displayed in the update candidate list display area 532. Radio buttons for enabling selection of a license to be updated are also provided in the update candidate list display area 532.

In this embodiment, by inputting a license ID of a post-update license, the user can obtain a list of candidate licenses to be updated in correspondence with the post-update license. Therefore, the user can acquire candidate licenses to be updated by a simple operation without having to, for example, create or input complicated search conditions (e.g., conditions shown in Step S154 of FIG. 13).

The button 533 is a button for accepting an instruction to update a license selected from the update candidate list display area 532. When the button 533 is pressed, the administrator terminal 30 designates a post-update license ID (“777777777”), a license ID of the license selected to be updated (hereinafter also referred to as “pre-update license ID”), and an organization ID of an organization to which the administrator terminal 30 belongs (hereinafter also referred to as “target organization ID”) and transmits a license update request (including the designated post-update ID, the pre-update license ID, and the target organization ID) to the service providing apparatus 20.

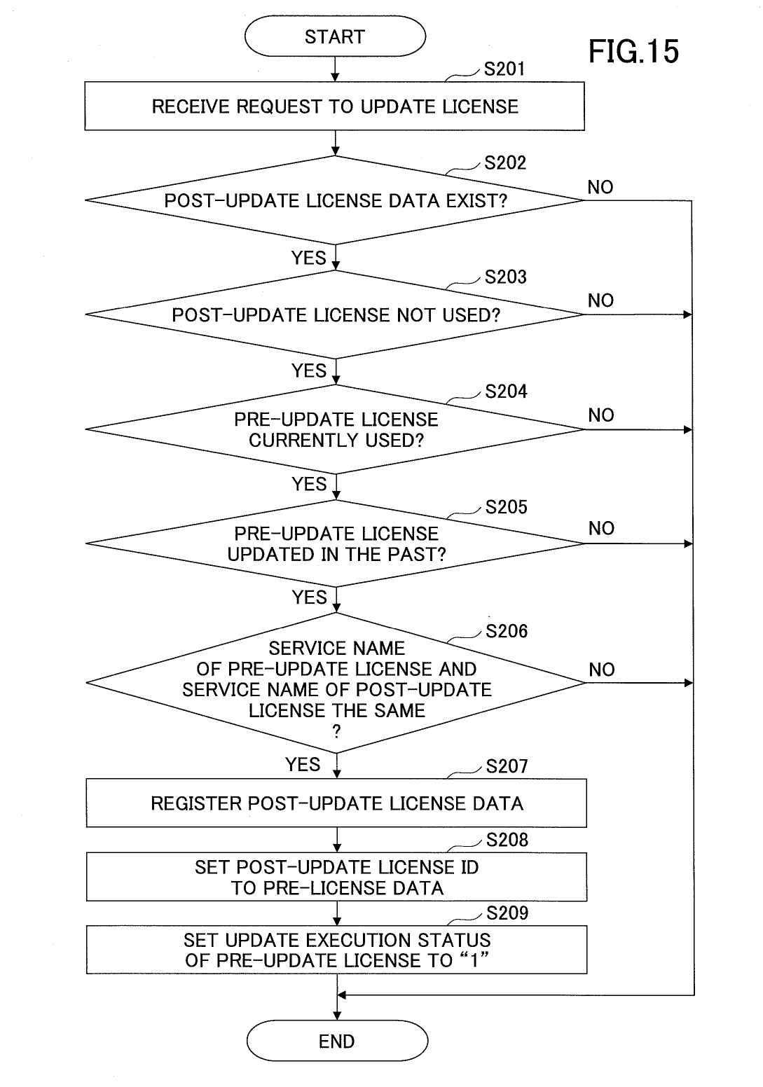

Next, processes performed by the service providing apparatus 20 in response to a license update request are described. FIG. 15 is a flowchart for describing processes performed in a license update procedure according to an embodiment of the present invention.

In Step S201, the request reception unit 2251 of the license management unit 225 receives a license update request. Then, the update unit 2257 of the license management unit 225 performs the same determining processes as those of Steps 102 and S103 of FIG. 7 on the post-update license (S202, S203). That is, in Step S202, the update unit 2257 determines whether contract data including both the target organization ID and the post-update license ID (hereinafter also referred to as “post-update contract data”) exists by way of the contract data access unit 41 of the contract data management apparatus 40. In a case where corresponding contract data is stored in the contract data storage unit 42 (Yes in Step S202), the update unit 2257 determines whether license data including both the post-update license ID and the target organization ID is stored in the license data storage unit 233 (Step S203).

In a case where corresponding license data is not stored in the license data storage unit 233 (Yes in Step S203), the update unit 2257 determines whether the status of a license data corresponding to the pre-update license ID and the target organization ID (hereinafter also referred to as “pre-update license data”) is “currently used” (Step S204). That is, the update unit 2257 determines whether the pre-update license is valid (i.e. whether pre-update license is within its validity period). For example, in Step S204, the update unit 2257 may determine whether the day of determination is within the validity period (defined by the date of start of use and the date of termination of use of the pre-update license data).

In a case where the status of the pre-update license data is “currently used” (Yes in Step S204), the update unit 2257 determines whether the update execution status of the pre-update license data is “0” (Step S205). That is, the update unit 2257 confirms whether the pre-update license has no prior record of having an updating procedure performed thereto.

In a case where the update execution status of the pre-update license data is “0” (Yes in Step S205), the update unit 2257 determines whether the service name of the pre-update license data is the same as the service name of the contract data corresponding to the post-update license ID (Step S206). This is because the post-update license is to be a license used for the same service as the pre-update license. In a case where the update execution status is not “0”, the pre-update license cannot be updated. Thus, the number of times of updates performed on each license can be restricted to one time.

In a case where the service names of the pre-update license and the post-update license match (Yes in Step S206), the update unit 2257 registers license data of the post-update license to the license data storage unit 233 (Step S207). Then, the update unit 2257 sets a post-update license ID to the “post-update ID” of the pre-update license data (Step S208). Thereby, the pre-update license and the post-update license can be associated with each other. Then, the update unit 2257 sets “1” to the “update execution status” of the pre-update license data (Step S209).

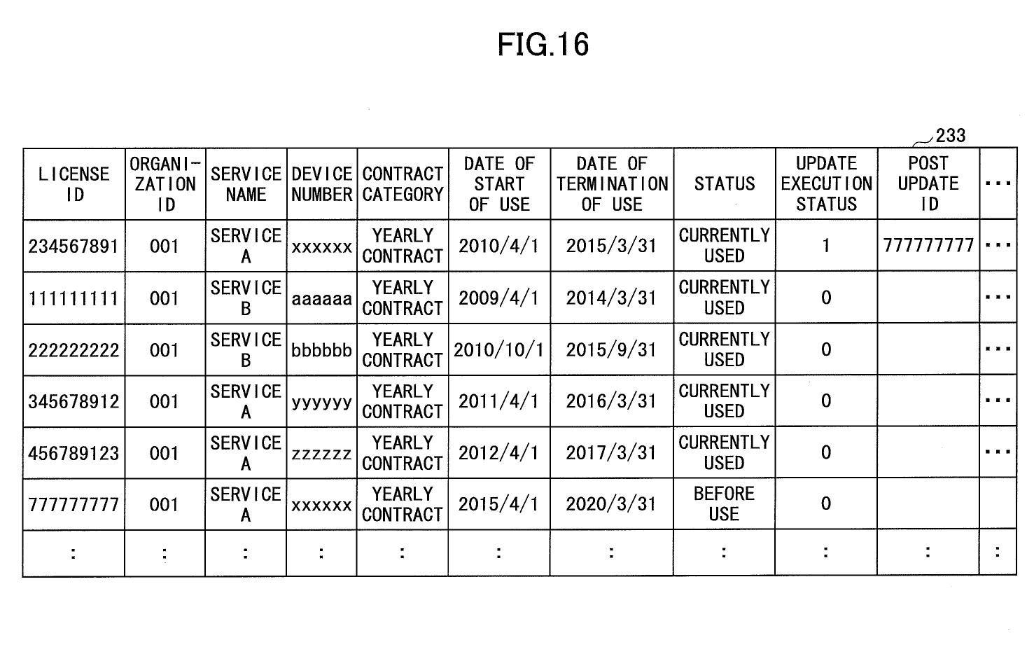

As a result of performing the processes in Step S207-S209, the license data storage unit 233 becomes a status as illustrated in, for example, FIG. 16.

FIG. 16 is a schematic diagram illustrating a configuration of the license data storage unit 233 after performing an updating procedure according to an embodiment of the present invention. FIG. 16 shows the results of an update procedure in which the post-update license is the license that corresponds to the contract data having license ID “777777777” in FIG. 8, and the license having license ID “234567891” is the license selected as the license to be updated (i.e. pre-update license).

As illustrated in FIG. 16, the device number of the pre-update license is stored in the “device number” of the record of the post-update license registered in Step S207. Further, the day after the date of termination of use of the pre-update license is stored in the “date of start of use” of the record of the post-update license. In other words, the validity period of the post-update license continues from the validity period of the pre-update license. The last day of a license period included in the contract data of the post-update license is stored in the “date of termination of use” of the record of the post-update license in a case where the “date of start of use” of the record of the post-update license is the starting point of the license period included in the contract data of the post-update license. Further, the status “before use” is stored in the “status” of the record of the post-update license. Further, the numeral “0” is stored in the “update execution status” of the record of the post-update license.

Then, in Step S208, the “update execution status” of the record of the pre-update license is updated to “1”. Then, in Step S209, the license ID of the post-update license “777777777” is stored in the “post-update ID” of the record of the pre-update license.

Assuming that the statuses of the licenses illustrated in FIG. 16 are applied to the example of FIG. 5, the license having the license ID “234567891” corresponds to the license having a “currently used (updated)” status whereas the license having the license ID “777777777” corresponds to the license having a “before use” status.

On the other hand, the license update request is denied when corresponding contract data is not stored in the contract data storage unit 42 (No in Step S202), when corresponding license data is stored in the license data storage unit 233 (No in Step S203), when the status of the pre-update license data is not “currently used” (No in Step S204), when the update execution status of the pre-update license data is “1” (No in Step S205), or when the service names of the pre-update license and the post-update license do not match (No in Step S206).

Next, processes performed by the service providing apparatus 20 in a case where a license period of a given license has expired are described.

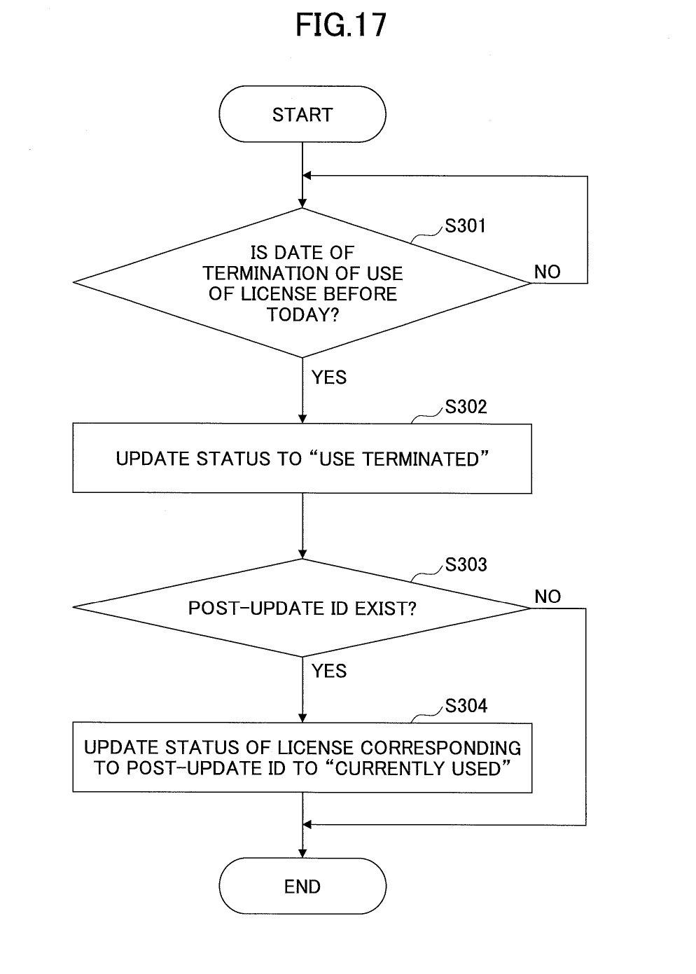

FIG. 17 is a flowchart for describing an example of processes performed in accordance with the expiration of a license period according to an embodiment of the present invention.

The use termination unit 2253 of the license management unit 225 detects the existence of a termination license (licenses having an expired license period) among the licenses stored in the license data storage unit 233. The detection is performed by determining whether any of the licenses having a “currently used” status in the license data storage unit 233 is a license having a “date of termination of use” that is before the day of the determination (Step S301). In a case where a license having a “date of termination of use” that is before the day of the determination is detected (Yes in Step S301), the use termination unit 2253 of the license management unit 225 updates the license status of the detected license stored in the license data storage unit 233, so that the status of the detected license is updated from “currently used” to “use terminated” (Step S302). For example, the detection of a termination license may be performed periodically (e.g., once everyday) by comparing the “date of termination of use” and the date of performing the detection. Alternatively, the detection of a termination license may be performed when accepting (receiving) any of the above-described requests (e.g., candidate search request, license update request) or when accepting a request to use a service in accordance with a given license.

Then, the use termination unit 2253 determines whether a license ID of another license is stored in the “post-update ID” of the license data of the detected termination license (Step S303). In a case where a license ID of another ID is stored in the “post-update ID” (Yes in Step S303), the use termination unit 2253 updates the status of the license data corresponding the license ID to the status “currently used” (Step S304). Thus, in a case where there is a post-update license corresponding to a license whose license period has expired (termination license), the service that was allowed to be used by the termination license can also be used by the post-update license.

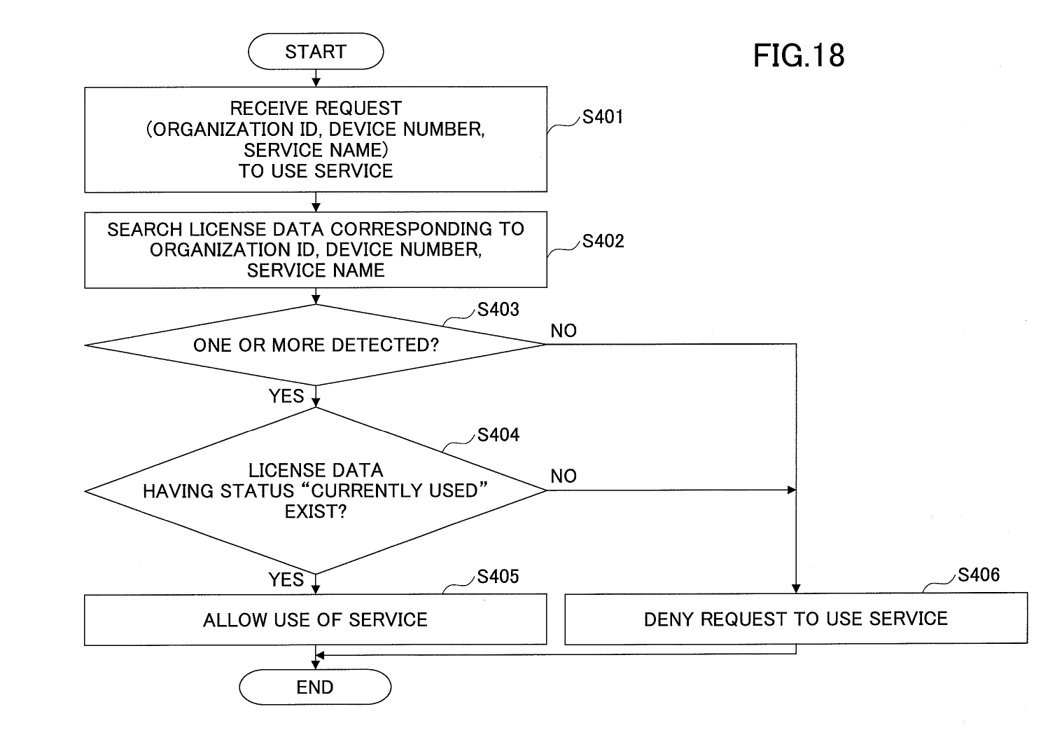

Next, a method of managing license based on license data is described. FIG. 18 is a flowchart for describing processes performed in accordance with a service use request.

When the service providing apparatus 20 receives a service use request (Step S401), the license control unit 2254 of the license management unit 225 searches through the license data storage unit 233 to acquire license data including data (e.g., organization ID, device number, service name) designated in the service use request (Step S402). For example, the service use request is transmitted from the device 10 to the service providing apparatus in accordance with instructions input by the user. The organization ID designated in the service use request is an organization ID of an organization to which the device 10 transmitting the service use request belongs. The device number designated in the service use request is a device number of the device 10 transmitting the service use request. The service name designated in the service use request is a service name of a service requested to be used.

In a case where one or more corresponding license data is found by the search (Yes in Step S403), the license control unit 2254 determines whether any of the license data includes a license having a “currently used” status (Step S404). In a case where corresponding license data exists (Yes in Step S404), the license control unit 2254 allows the use of the service corresponding to the designated service name (Step S405).

On the other hand, the license control unit 2254 denies the request to use the service designated in the service use request when no corresponding license data including the designated organization ID, the device number, and the service name is found (No in Step S403) or when no corresponding license data exists (No in Step S404). Thus, in this case, the user is unable to use a service provided by the service providing apparatus 20 by using the device 10 corresponding to the designated device number.

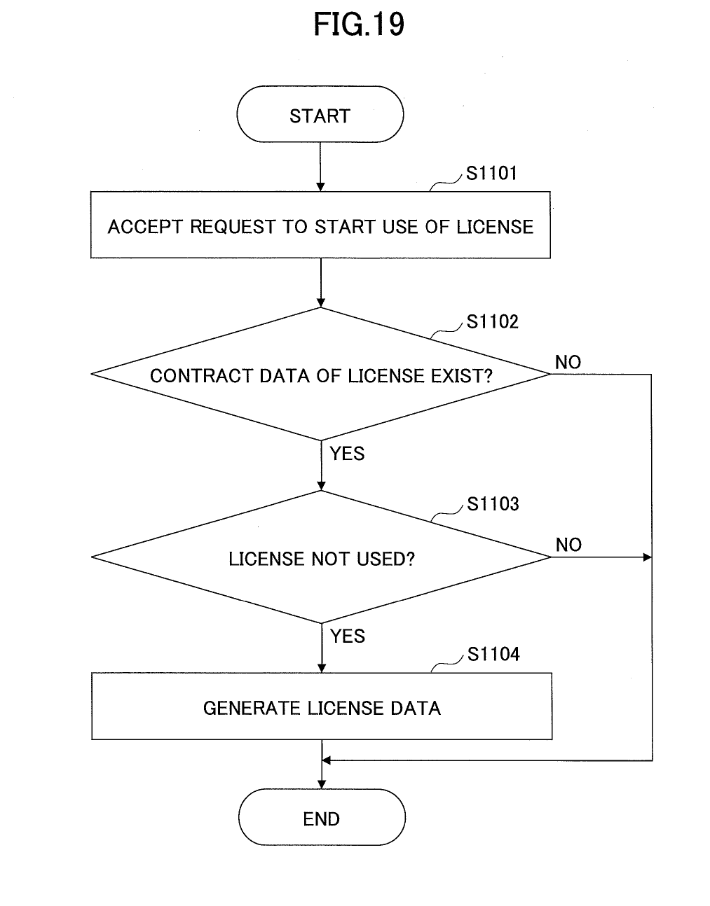

Next, processes performed by the service providing apparatus 20 according to another embodiment of the present invention are described. FIG. 19 is a flowchart for describing processes performed when starting the use of a license. For example, the processes illustrated in FIG. 19 are performed when starting the use of a license that is not a post-update license (e.g., license L1 of FIG. 5).

In Step S1101, the license management unit 225 accepts a request to start use of a license (license use start request). For example, the license use start request may be transmitted from the administrator terminal 30 to the service providing apparatus 20 in accordance with instructions input by an administrator. A license ID (identification data) of a license to be used (target license), a device number of the device 10 that is to use the target license, and identification data of a user that is to use the license are designated with the license use start request. In this embodiment, an organization ID serves as the identification data of the user that is to use the license. The organization ID is identification data of an organization including the user environment E1. For example, the organization ID may be identification data that identifies a company or a section or department of the company. The organization ID may also be identification data corresponding to a group of multiple users. Further, before receiving the license use start request, an authentication process may be performed on the user. In a case where an organization ID is designated during the authentication process, the license use start request need not include a designation of the organization ID.

Further, the device number of the device 10 (that is to use the target license) is identification data of the device 10 that is to use the device coordination service according to the target license. That is, in this embodiment, a license of the device coordination service is associated with a corresponding device 10. In other words, a single license allows only a single device 10 to use the device coordination service. As long as the device 10 can be distinguished from another device 10, the device number is not limited to particular data. For example, the device number of the device 10 may be a product number of the device 10 or a MAC address of the device 10.

The license ID, the device number, the organization ID that are designated with the license use start request may hereinafter be referred to as “target license ID”, “target device number”, and “target organization ID”.

Then, the license management unit 225 determines whether contract data corresponding to the target organization ID and the target license ID exist by way of the contract data access unit 41 of the contract data management unit 40 (Step S1102). The existence of contract data is determined by determining whether corresponding contract data is stored in the contract data storage unit 42.

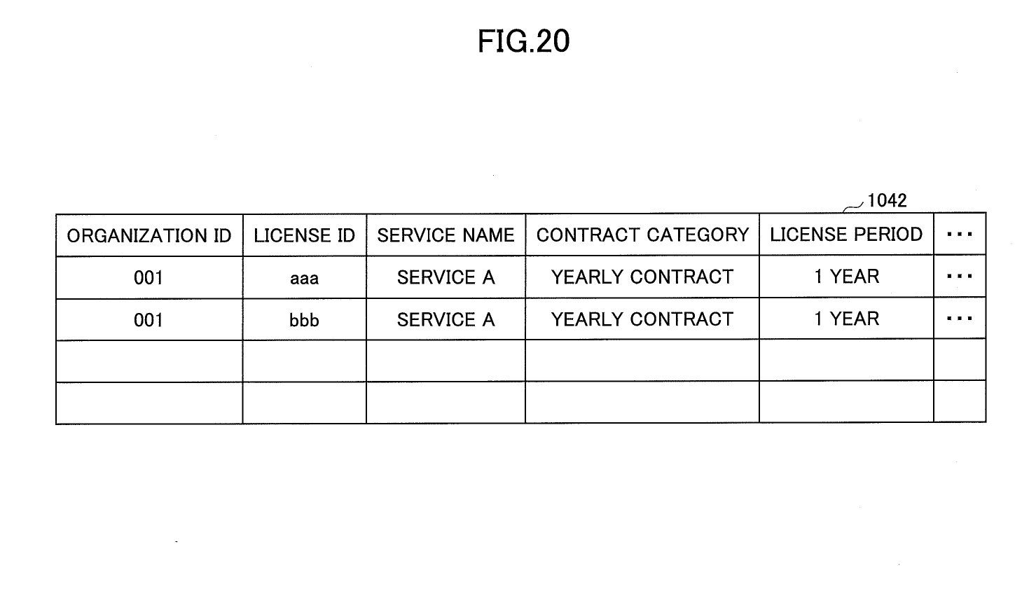

FIG. 20 is a schematic diagram illustrating a configuration of the contract data storage unit 42 according to another embodiment of the present invention. In FIG. 20, a contract data storage unit 1042 stores a record indicating contract data in correspondence with each contract to use the device coordination service (usage contract). The contract data includes, for example, an organization ID, a license ID, a service name, a contract category, and a license period.

The organization ID is an organization ID of a user agreeing to the usage contract. The license ID is a license ID of a license purchased according to the usage contract. The service name is an identification name of the device coordination service subjected to the usage contract. In a case where there are services belonging to the same service type but have different functions, there may be a desire to change the name of service (service name) in correspondence with each function. In this case, “service name” may be replaced with, for example, “service type”. The contract category is a category for indicating the method for updating a license purchased according to the usage contract. In this embodiment, “contract category” includes, for example, “yearly contract” and “automatic update”. The contract category “yearly contract” indicates that an updating procedure is to be performed on a yearly basis. The contract category “automatic update” indicates that a validity period of a license is automatically updated. In other words, “automatic update” means that the validity period of the license is indefinite. The license period is a validity period of a license purchased according to the usage contract.

In a case where contract data including both the target organization ID and the target license ID (hereinafter also referred to as “target contract data”) exists (Yes in Step S102), the license management unit 225 determines whether the license corresponding to the target contract data is already being used (Step S103). The determination of the use of the license corresponding to the contract data may be performed by, for example, referring to the license data storage unit 233.

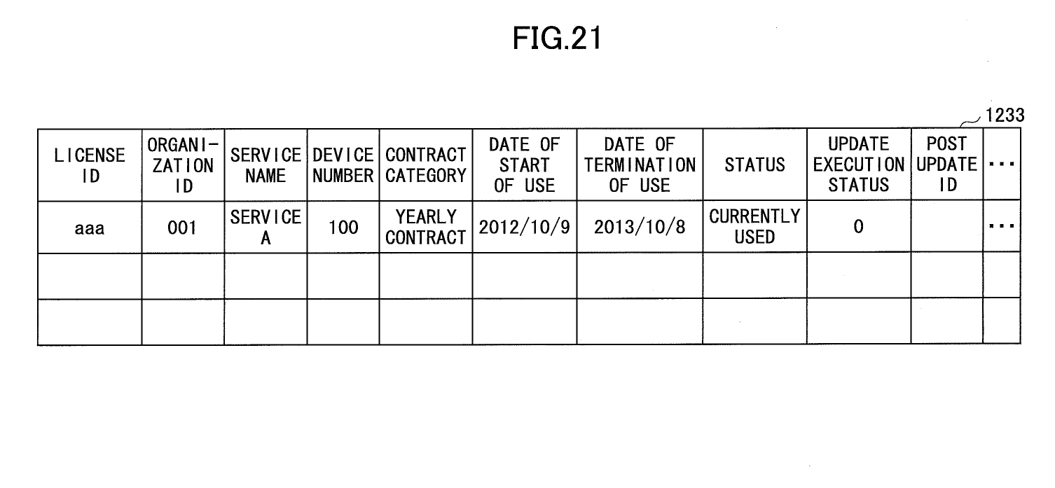

FIG. 21 is a schematic diagram illustrating a configuration of the license data storage unit 1233 according to another embodiment of the present invention. The license data storage unit 1233 of FIG. 21 stores records indicating license data in correspondence with each license which has already started to be used. The license data includes, for example, a license ID, an organization ID, a service name, a device number, a contract category, a date of start of use, a date of termination of use, a status, an update execution status, and a post-update ID (ID assigned after an updating procedure).

The “license ID” indicates an ID of a license. The “organization ID” indicates an organization ID of a user that has purchased the license. The “service name” indicates a service name of a device coordination service to be used with the license. The “device number” indicates a device number of the device that can use (allowed to use) the device coordination service. The “contract category” indicates a contract category of the license. The “date of start of use” indicates the date of the start of the validity period of the license. The “date of termination of use” indicates the date of the end of the validity period of the license. The “status” indicates the status of the license (i.e. transition of statuses illustrated in FIG. 5). The “update execution status” indicates whether there is a past record of performing an updating procedure on the license. For example, in a case where the “update execution status” is “1”, an updating procedure has been performed on the license. In a case where the “update execution status” is “0”, an updating procedure has not been performed on the license. In other words, the “update execution status” serves an item for distinguishing whether the status of the license is “currently used (not yet updated)” or “currently used (updated)” as illustrated in FIG. 5. The “post-update ID” indicates a license ID of a post-update license corresponding to a license on which an updating procedure has been performed. For example, in the embodiment of FIG. 5, the post-update ID of the license L1 would be the license ID of the license L2. Further, the post-update ID of the license L2 would be the license ID of the license L3.

Further, in Step S1103, it is determined whether a record including both the target license ID and the target organization ID is stored in the license data storage unit 1233.

In a case where a recording including both the target license ID and the target organization ID is not stored in the license data storage unit 1233 (Yes in Step S1103), the license management unit 225 generates license data corresponding to the license ID and registers the generated license data to the license data storage unit 1233 (Step S1104). For example, in a case where the target contract data corresponds to the contract data in row 1 of the contract data storage unit 1042 of FIG. 20, the records (license data) of row 1 in the license data storage unit 1233 of FIG. 21 would be the license data recorded to the license data storage unit 1233 in Step S1104.

The values included in the target contract data are copied (stored) in the license ID, the organization ID, the service ID, the service name, and the contract category of the records. The date of receiving the license use start request is stored in the “date of start of use” of a corresponding record of the license data storage unit 1233.

Alternatively, a specific date may be designated as “date of start of use” by the license use start request. In this case, the specific date designated in the license use start request may be stored in the “date of start of use” of a corresponding record of the license data storage unit 1233.

The last day of the license period included in the contract data is stored in the “date of termination of use” of a corresponding record of the license data storage unit 1233 where the “date of start of use” of the record is the starting point of the license period. The target device number is stored in the “device number” of a corresponding record of the license data storage unit 1233. The status “currently used” is stored in the “status” of a corresponding record of the license data storage unit 1233. The numeral “0” is stored in the “update execution status” of a corresponding record of the license data storage unit 1233. Because the updating procedure has not yet been performed on the license of the record (license data) registered in Step S1104, no data is stored in the “post-update ID” of a corresponding record of the license data storage unit 1233.

In a case where the target contract data is not stored in the contract data storage unit 1042 (No in Step S1102) or where license data corresponding to the target contract data is stored in the license data storage unit 1233 (No in Step S1103), the license use start request is denied.

Next, another embodiment of processes performed by the license providing apparatus 20 in a case of performing an updating procedure on a currently used license is described.

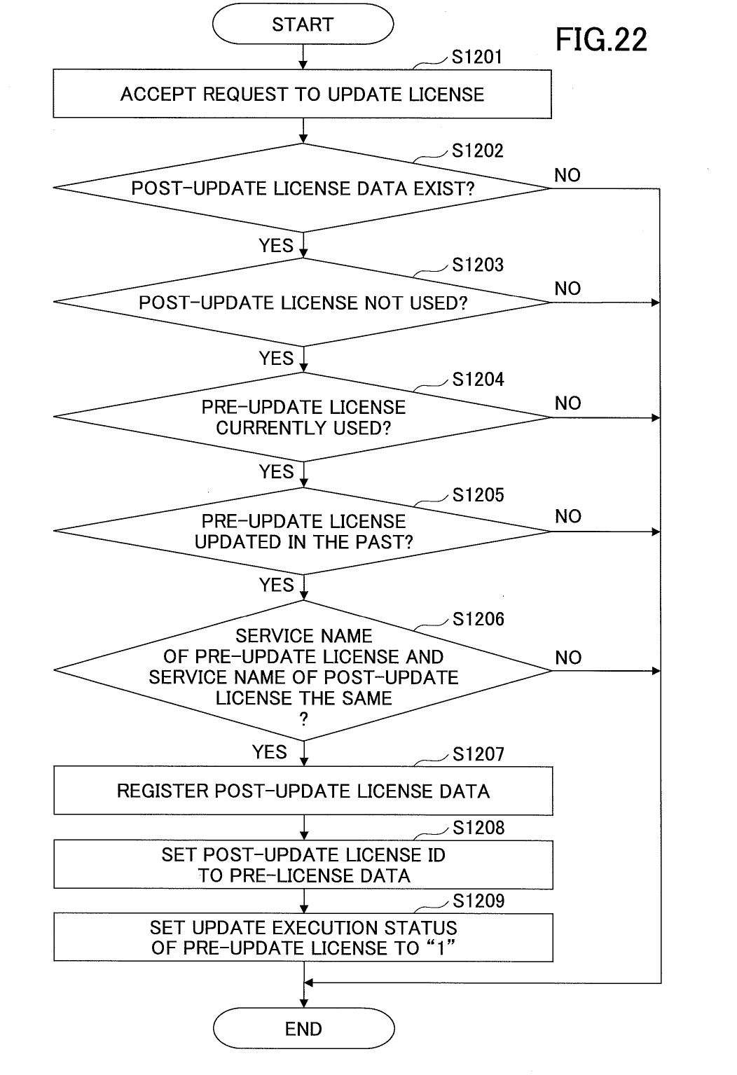

FIG. 22 is a flowchart for describing processes performed in a license update procedure according to another embodiment of the present invention.

In Step S1201, the license management unit 225 accepts a request to update a license (license update request). For example, the license update request may be transmitted from the administrator terminal 30 to the service providing apparatus 20 according to instructions input to the administrator terminal 30 by an administrator. For example, a license ID of a license to be updated (license corresponding to pre-update license), a license ID of a post-update license, and an organization ID of the user requesting the update (i.e. origin of the license update request) are designated with the license update request. These parameters with the license update request may be hereinafter referred to as “pre-update license ID”, “post-update license ID”, and “target organization ID”, respectively.

Then, the license management unit 225 performs the same determining processes as those of Steps 1102 and 51103 of FIG. 19 on the post-update license (S1202, S1203). That is, in Step S1202, the license management unit 225 determines whether contract data including both the target organization ID and the post-update license ID (hereinafter also referred to as “post-update contract data”) exists by way of the contract data access unit 41 of the contract data management apparatus 40. In a case where corresponding contract data is stored in the contract data storage unit 42 (Yes in Step S1202), the license management unit 225 determines whether license data including both the post-update license ID and the target organization ID is stored in the license data storage unit 1233 (Step S1203).

In a case where corresponding license data is not stored in the license data storage unit 1233 (Yes in Step S1203), the license management unit 225 determines whether the status of a license data corresponding to the pre-update license ID and the target organization ID (hereinafter also referred to as “pre-update license data”) is “currently used” (Step S1204). That is, the license management unit 225 determines whether pre-update license is within its validity period. For example, in Step S1204, the license management unit 225 may determine whether the day of determination is within the validity period (defined by the date of start of use and the date of termination of use of the pre-update license data).

In a case where the status of the pre-update license data is “currently used” (Yes in Step S1204), the license management unit 225 determines whether the update execution status of the pre-update license data is “0” (Step S1205). That is, the license management unit 225 confirms whether the pre-update license has no prior record of having an updating procedure performed thereto.

In a case where the update execution status of the pre-update license data is “0” (Yes in Step S1205), the license management unit 225 determines whether the service name of the pre-update license data is the same as the service name of the contract data corresponding to the post-update license ID (Step S1206). This is because the post-update license is to be a license used for the same service as the pre-update license. In a case where the update execution status is not “0”, the pre-update license cannot be updated. Thus, the number of times of updates performed on each license can be restricted to one time.

In a case where the service names of the pre-update license and the post-update license match (Yes in Step S1206), the license management unit 225 registers license data of the post-update license to the license data storage unit 233 (Step S1207). Then, the license management unit 225 sets a post-update license ID to the “post-update ID” of the pre-update license data (Step S1208). Thereby, the pre-update license and the post-update license can be associated with each other. Then, the license management unit 225 sets “1” to the “update execution status” of the pre-update license data (Step S1209).

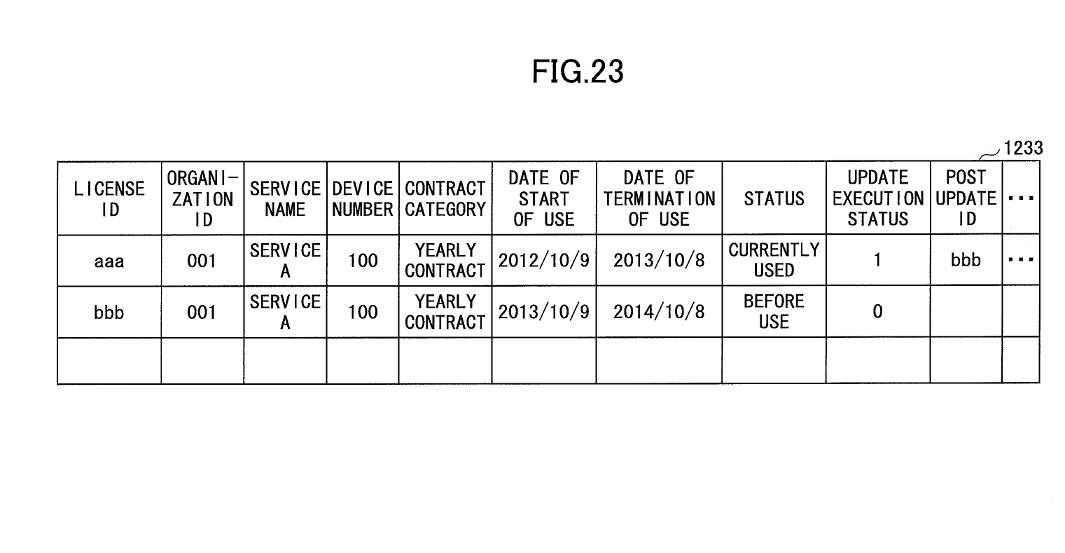

As a result of performing the processes in Step S1207-S1209, the license data storage unit 1233 becomes a status as illustrated in, for example, FIG. 23.

FIG. 23 is a schematic diagram illustrating a configuration of the license data storage unit 1233 after performing an updating procedure according to another embodiment of the present invention. FIG. 23 shows the results of an update procedure in which the post-update license is the license that corresponds to the contract data having license ID “bbb” in FIG. 23. Further, the license having license ID “aaa” is the license that is selected as the license to be updated (i.e. pre-update license) and corresponds to the post-update license having license ID “bbb”.

As illustrated in FIG. 23, the device number of the pre-update license is stored in the “device number” of the record of the post-update license registered in Step S1207. Further, the day after the date of termination of use of the pre-update license is stored in the “date of start of use” of the record of the post-update license. In other words, the validity period of the post-update license continues from the validity period of the pre-update license. The last day of a license period included in the contract data of the post-update license is stored in the “date of termination of use” of the record of the post-update license in a case where the “date of start of use” of the record of the post-update license is the starting point of the license period included in the contract data of the post-update license. Further, the status “before use” is stored in the “status” of the record of the post-update license. Further, the numeral “0” is stored in the “update execution status” of the record of the post-update license.

Then, in Step S1208, the “update execution status” of the record of the pre-update license is updated to “1”. Then, in Step S1209, the license ID of the post-update license “bbb” is stored in the “post-update ID” of the record of the pre-update license.

Assuming that the statuses of the licenses illustrated in FIG. 23 are applied to the example of FIG. 5, the license having the license ID “aaa” corresponds to the license having a “currently used (updated)” status whereas the license having the license ID “bbb” corresponds to the license having a “before use” status.

On the other hand, the license update request is denied when corresponding contract data is not stored in the contract data storage unit 1042 (No in Step S1202), when corresponding license data is stored in the license data storage unit 1233 (No in Step S1203), when the status of the pre-update license data is not “currently used” (No in Step S1204), when the update execution status of the pre-update license data is “1” (No in Step S1205), or when the service names of the pre-update license and the post-update license do not match (No in Step S1206).

Next, another embodiment of processes performed by the service providing apparatus 20 in a case where a license period of a given license has expired is described.

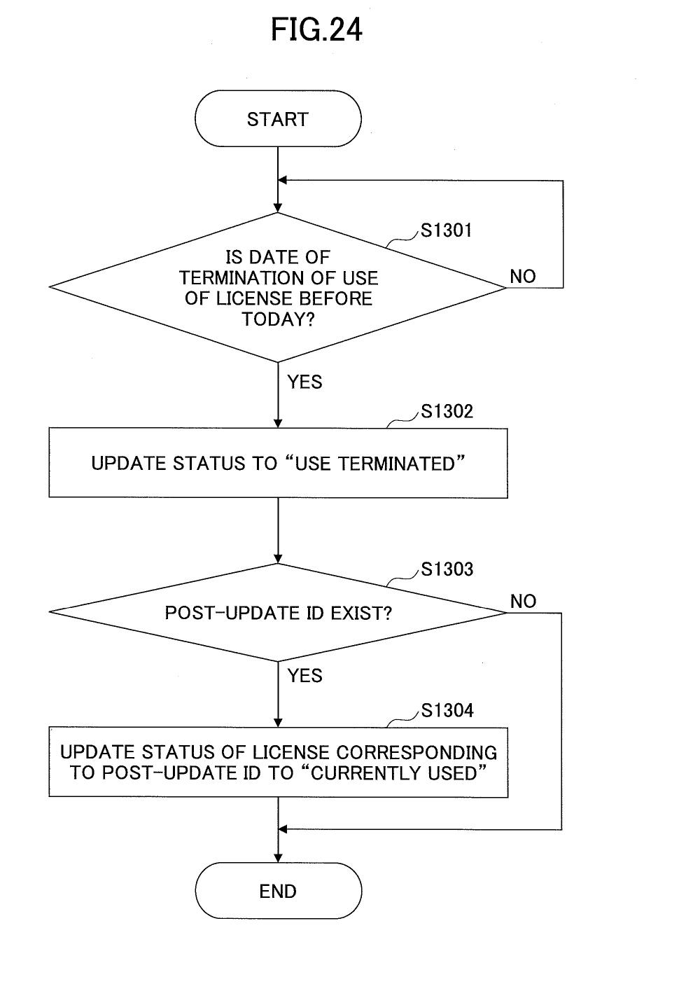

FIG. 24 is a flowchart for describing an example of processes performed in accordance with the expiration of a license period according to another embodiment of the present invention.

The license management unit 225 detects the existence of a termination license (licenses having an expired license period) among the licenses stored in the license data storage unit 1233. The detection is performed by determining whether any of the licenses having a “currently used” status in the license data storage unit 1233 is a license having a “date of termination of use” that is before the day of the determination (Step S1301). In a case where a license having a “date of termination of use” that is before the day of the determination is detected (Yes in Step S1301), the license management unit 225 updates the license status of the detected license stored in the license data storage unit 1233, so that the status of the detected license is updated from “currently used” to “use terminated” (Step S1302). For example, the detection of a termination license may be performed periodically (e.g., once everyday) by comparing the “date of termination of use” and the date of performing the detection. Alternatively, the detection of a termination license may be performed during the processes of FIG. 19 or 22, or when accepting a request to use a service in accordance with a given license.

Then, the license management unit 225 determines whether a license ID of another license is stored in the “post-update ID” of the license data of the detected termination license (Step S1303). In a case where a license ID of another ID is stored in the “post-update ID” (Yes in Step S1303), the license management unit 225 updates the status of the license data corresponding the license ID to the status “currently used” (Step S1304). Thus, in a case where there is a post-update license corresponding to a license whose license period has expired (termination license), the service that was allowed to be used by the termination license can also be used by the post-update license.

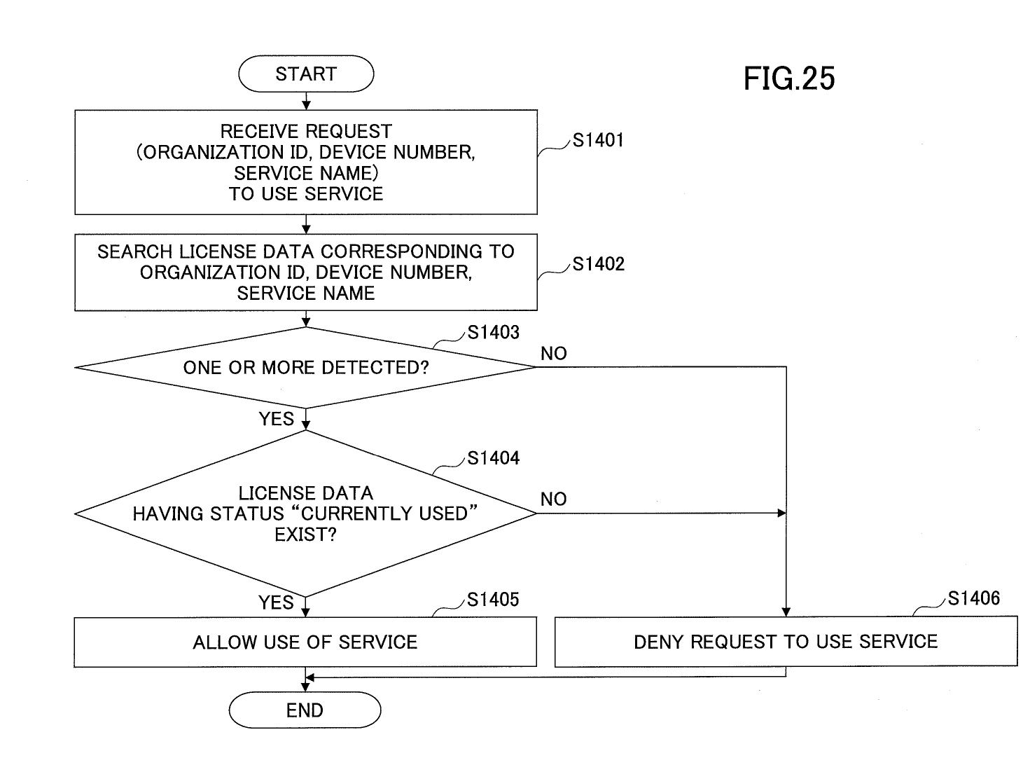

Next, another embodiment of a method of managing license based on license data is described. FIG. 25 is a flowchart for describing processes performed in accordance with a service use request.

When the service providing apparatus 20 receives a service use request (Step S1401), the license management unit 225 searches through the license data storage unit 1233 to acquire license data including data (e.g., organization ID, device number, service name) designated in the service use request (Step S1402). For example, the service use request is transmitted from the device 10 to the service providing apparatus in accordance with instructions input by the user. The organization ID designated in the service use request is an organization ID of an organization to which the device 10 transmitting the service use request belongs. The device number designated in the service use request is a device number of the device 10 transmitting the service use request. The service name designated in the service use request is a service name of a service requested to be used.

In a case where one or more corresponding license data is found by the search (Yes in Step S1403), the license management unit 225 determines whether any of the license data includes a license having a “currently used” status (Step S1404). In a case where corresponding license data exists (Yes in Step S1404), the license control unit 2254 allows the use of the service corresponding to the designated service name (Step S1405).

On the other hand, the license management unit 225 denies the request to use the service designated in the service use request when no corresponding license data including the designated organization ID, the device number, and the service name is found (No in Step S1403) or when no corresponding license data exists (No in Step S1404). Thus, in this case, the user is unable to use a service provided by the service providing apparatus 20 by using the device 10 corresponding to the designated device number.

With the above-described embodiment of the present invention, candidates of licenses to be updated can be easily specified by the designation of the post-update license. Therefore, the updating procedure of licenses (license updating procedure) can be facilitated.

Further, with the above-described embodiment of the present invention, there can be provided a new type of managing licenses that can have their validity periods updated. More specifically, the license data of the license data storage unit 233 and the contract data of the contract data storage unit 42 can be associated with each other on a one-on-on basis even after performing an updating procedure on a license. As a result, the user can identify a usage contract that is associated with a license that is currently used.

Further, with the above-described embodiment of the present invention, an updating procedure can only be performed once on a single license. As a result, problems such as overlapping of validity periods with respect to the same service or generation of multiple licenses corresponding to the same device number can be prevented. That is, in a case where multiple licenses can only be used by the same device 10 during the same period, all of the multiple licenses would be wasted except for one license. However, with the above-described embodiment of the present invention, such waste of licenses can be prevented for the user.

Further, with the above-described embodiment of the present invention, the status of a license that can be updated is limited to a license having a currently used status with a valid license period.

Therefore, an unlimited chain of updates can be prevented from being performed on a license. In the example of FIG. 5, a license that can be chained to the license L1 is limited to only a single license (in the example of FIG. 5, license L2). Thus, the license L1 cannot be chained to the license L2 simultaneously with chaining the license L2 to the license L3. As a result, an update allowing a service to be used beyond a license period of the service can be prevented.

In the above-described embodiments of the present invention, the service providing apparatus 20 is one example of a license management apparatus or a license management system. The license data storage unit 233 is one example of a storage unit. The request reception unit 2251 is one example of a reception unit. The response reply unit 2258 is one example of a reply unit. The update candidate search unit 2256 is one example of a search unit. The update unit 2257 is one example of a registration unit. Further, the license data storage unit 1233 is another example of the storage unit. The license management unit 225 is another example of the registration unit and an example of a determination unit.

Various aspects of the subject-matter described herein are set out non-exhaustively in the following numbered clauses:

1. A license management apparatus comprising:

a storage unit configured to store a first license data corresponding to a predetermined service;

a registration unit configured to register, in response to a request to update a validity period of the first license data, a second license data having a validity period that continues from the validity period of the first license data; and

a determination unit configured to determine allowance of use of the predetermined service according to license data stored in the storage unit.

2. The license management apparatus of clause 1, wherein after the second license data is registered, the registration unit is configured to deny registration of a license data having a validity period that continues from the validity period of the first license data in a case where a request to update the predetermined validity period of the first license data is received for a second time or after.

3. The license management apparatus of clause 1 or 2, wherein the registration unit is configured to register the second license data in a case where a timing of receiving the request to update the predetermined validity period of the first license data is within the validity period of the first license data.

4. A license management system including one or more computers, the license management system comprising:

a storage unit configured to store a first license data corresponding to a predetermined service;

a registration unit configured to register, in response to a request to update a validity period of the first license data, a second license data having a validity period that continues from the validity period of the first license data; and

a determination unit configured to determine allowance of use of the predetermined service

5. A method for causing a computer to execute a license management process, the license management process comprising the steps of:

registering, in response to a request to update a validity period of a first license data stored in a storage unit, a second license data having a validity period that continues from the validity period of the first license data to the storage unit; and

determining allowance of use of the predetermined service according to license data stored in the storage unit.

The present invention is not limited to the specifically disclosed embodiments, and variations and modifications may be made without departing from the scope of the present invention.

### [Patent Document 1]

Japanese Laid-Open Patent Publication No. 2005-327196

### [Patent Document 2]

Japanese Laid-Open Patent Publication No. 2009-087065

The present application is based upon and claims the benefit of priority of Japanese Priority Application Nos. 2012-236409 and 2012-236410, filed on Oct. 26, 2012, respectively, the entire contents of which are hereby incorporated herein by reference.

What is claimed is:

1. A license management apparatus comprising:
a reception unit configured to receive identification data of a second license corresponding to a predetermined service;
a search unit configured to search for license data of a first license corresponding to a service matching the predetermined service, in a storage unit that stores license data including status data of each license; and
a transmission unit configured to transmit a search result of the search by the search unit;
wherein the second license is a license that is not yet used and the first license is license that is currently used.

2. The license management apparatus as claimed in claim 1,
wherein the identification data of the second license is input from a first screen displayed on a terminal connected to the license management apparatus via a network,
wherein the search result is displayed on a second screen of the terminal;

3. The license management apparatus as claimed in claim 1, further comprising:
a registration unit;
wherein the search result includes first license data having a predetermined validity period,
wherein the reception unit is configured to receive a request to update the predetermined validity period of the first license data,
wherein the registration unit is configured to register a second license data having a validity period that continues from the predetermined validity period of the first license data.

4. The license management apparatus as claimed in claim 3, wherein in a case where the reception unit receives the request to update the predetermined validity period of the first license data for a second time or after, the registration unit configured to deny registration of the second license data.

5. The license management apparatus as claimed in claim 3,
wherein the registration unit is configured to register the second license data in a case where a timing of receiving the request to update the predetermined validity period of the first license data is within the predetermined validity period of the first license data.

6. A license management system comprising:
a first computer configured to transmit identification data of a second license corresponding to a predetermined service; and
a second computer including
a reception unit configured to receive the identification data of a second license corresponding to a predetermined service,
a search unit configured to search for license data of a first license corresponding to a service matching the predetermined service, in a storage unit that stores license data including status data of each license,
a transmission unit configured to transmit a search result of the search by the search unit to the first computer;
wherein the second license is not yet used and the first license is currently used.

7. A license management method, the method comprising the steps of:
receiving identification data of a second license corresponding to a predetermined service;
searching for license data of a first license corresponding to a service matching the predetermined service, in a storage unit that stores license data including status data of each license; and
transmitting a search result of the search by the searching step;
wherein the second license is not yet used and the first license is currently used.
